(19) United States
(12) Patent Application Publication
(10) Pub. No.: US 2010/0217672 A1
(43) Pub. Date: Aug. 26, 2010

(54) Positional Information Analysis Apparatus, Positional Information Analysis Method, and Positional Information Analysis System

(75) Inventor: Kurato Maeno, Saitama (JP)

Correspondence Address: RABIN & Berdo, PC, 1101 14TH STREET, NW, SUITE 500, WASHINGTON, DC, 20005, US

(73) Assignee: Oki Electric Idustry Co., Ltd., Tokyo (JP)

(21) Appl. No.: 12/679,035

(22) PCT Filed: May 19, 2008
(86) PCT No.: PCT/JP2008/059153

§ 371 Date: Mar. 19, 2010

(30) Foreign Application Priority Data
Sep. 19, 2007 (JP) 2007-242086

(51) Int. Cl. G06Q 30/00; G08B 13/14

(52) U.S. Cl. 705/14.58; 340/572.1

(57) ABSTRACT

A positional information analysis device includes: a position detecting unit that calculates positional information of a mobile station unit; a positional information storage unit that stores the positional information as a history for the mobile station unit; a state attribute calculating unit that calculate state attribute information which indicates a state of the mobile station unit from the history of the positional information of the mobile station unit each time the position of the mobile station unit is calculated; a meaning conversion rule storage unit that stores a first identifier given to a meaning of a movement of a mobile station unit and a rule which detects the meaning of the movement so as to associate the first identifier and the rule with each other; and a rule-positional information correlation calculating unit that determines whether the rule is matched and outputs the first identifier associated with the rule.

### TECHNICAL FIELD

The present invention relates to a positional information analysis apparatus, a positional information analysis method, and a positional information analysis system that continuously detect a position of a detection target and analyze a meaning of a movement of the detection target from continuous positional information.

### BACKGROUND ART

In recent years, for example, in the fields of measurement of a traffic flow, measurement of a degree of congestion of persons, and analysis of a movement line of customers in a supermarket, a technique has been used which detects a position of a moving body, such as a person or an article, and acquires a transition of the position of a moving body over time as a movement line. For example, in the analysis of the movement line of the customers in the supermarket, a quantity of flow and/or an amount of access to each passage or shelf are analyzed on the basis of the movement lines of the customers, and a store layout or space management is changed on the basis of the analysis result. In recent years, a technique has been proposed which identifies each moving body or an attribute and detects a position and a movement line of each moving body. For example, it is possible to know ‘who’ has visited a store, ‘when’ a person has visited a store, and ‘where’ a person has visited.

For example, Patent Document 1 (Japanese Patent Application Laid-Open (JP-A) No. 2000-090149) discloses a technique that detects a movement line of a customer from a transition in a position of the customer over time which is accompanied with a movement of the customer with a wireless IC tag and tracks the position of the customer. Patent Document 2 (Japanese Patent Application Laid-Open (JP-A) No. 2000-200357) discloses a technique which identifies a person from images captured by a monitoring camera and detects and tracks a moving body in cooperation with plural monitoring cameras in order to specify a movement path of a person. Patent Document 3 (Japanese Patent Application Laid-Open (JP-A) No. 2006-236146) discloses a method of estimating a position of a moving body using a radio field intensity of a wireless LAN and a technique which reads an RFID (Radio Frequency Identification) provided in a shelf using an RFID reader to continuously estimate a position of a shopping cart and detects a movement line of each shopping cart. Non-patent Document 1 ('Estimation of Ambulatory Activity Utilizing Portable Instruments', The Society of Instrument and Control Engineers, Tohoku Chapter, 222nd Workshop, Jun. 29, 2005, Document No. 222-10) discloses a technique that continuously estimates a position of a moving body using a dead-reckoning method using, for example, an acceleration sensor.

Non-patent Document 2 (IEEE802.15.4a) discloses a technique which detects a position of a moving body with high accuracy using an impulse radio system, which is a UWB (Ultra Wide Band) wireless technique. This is a wireless system using an extremely short pulse wave of about 1 ns, and can accurately detect a distance between a transmitter and a receiver using an arrival time of radio signals. In addition, the transmitter can transmit an ID in order to perform wireless communication, and it is possible to specify a position of an individual such that the individual can be identified.

The extremely short pulse wave used in the impulse radio system is less likely to be affected by fading. Therefore, it is possible to measure an arrival time of electrical waves with high accuracy. The use of the above-mentioned technique makes it possible to identify each person and detect the position thereof even in a congested area and calculate the movement line of each person with high accuracy. In the impulse radio system, the structure of a wireless circuit is very simple, and power consumption is small. For example, a high-accuracy position detecting system using ultrasonic waves has been put to practical use, in addition to the impulse radio system.

In the field of the analysis of the movement lines of customers, for example, the following methods have been proposed: a method of measuring a time when a customer stays in order to check customer's preference; and a method of accurately analyzing customer's preference in association with purchase information during accounting (for example, Patent Document 4). In addition, a technique has been proposed which detects movement lines of plural persons, rather than a position of an individual person, and a positional relationship between the persons, thereby calculating a degree of congestion (for example, Patent Document 5). As such, the following techniques have been proposed: a technique for identifying a moving body, such as a person or an article, and detecting a transition in the position of the moving body as a movement line; and a customer movement line analysis technique based on simple meaning analysis from a movement line, such as association between ‘a time for which a person stays before an article’ and ‘an interest of the person in the article’.

Patent Document 1: Japanese Patent Application Laid-Open (JP-A) No. 2000-090149

Patent Document 2: Japanese Patent Application Laid-Open (JP-A) No. 2000-200357

Patent Document 3: Japanese Patent Application Laid-Open (JP-A) No. 2006-236146

Patent Document 4: Japanese Patent Application Laid-Open (JP-A) No. 08-137916

Patent Document 5: Japanese Patent Application Laid-Open (JP-A) No. 2006-133911

Non-patent Document 1: ‘Estimation of Ambulatory Activity Utilizing Portable Instruments’, The Society of Instrument and Control Engineers, Tohoku Chapter, 222nd, Jun. 29, 2005, Document No. 222-10

Non-patent Document 2: IEEE802.15.4a

### DISCLOSURE OF THE INVENTION

### Problem to be Solved by the Invention However, in the above-mentioned movement line analysis technique, it is impossible to analyze and utilize a movement line in real time. For example, when positional information is wirelessly received, an interval at which wireless antennas are provided affects a reception rate of signals, and positional accuracy is lowered due to, for example, a reception of signals by a wireless antenna other than the closest wireless antenna. When an individual is identified or a movement line is detected by image processing, there is a limitation in identifying the individual using a remote monitoring camera. It is difficult to accurately maintain a movement line with one attribute for a long time in the detection of the movement line. As a result, it is difficult to accurately track movement lines of plural persons. Regarding a movement of an individual, it is possible to accurately detect the movement of the individual using a sensor for detecting movement, such as an acceleration sensor. However, complicated processing is necessary to detect a movement line from the movement, and position errors of the individual are likely to be accumulated.

As such, it is impossible to accurately estimate a meaning of a movement of an individual moving body from a position or a movement line obtained from a conventional detecting system which has a low detection accuracy of about several meters. Therefore, a conventional detecting system only acquires information such as confirmation of an existence at an approximate position of a moving body, statistical estimation of a movement line or a degree of congestion, statistical detection of a main route, and estimation of an approximate behavior on the basis of whether an individual passes through a route. That is, it is impossible for a conventional low-accuracy detecting system to acquire in real time a minute movement of a moving body that continuously changes over time or a relation between movements of plural persons and detect a meaning of the movement of each moving body in real time.

Therefore, the invention provides a new and improved positional information analysis apparatus, a positional information analysis method, and a positional information analysis system capable of analyzing a meaning of a movement line of each moving body in real time from the movement line, which is a transition in positional information over time, using high-accuracy positional information of the moving body which is obtained by, for example, a high-accuracy position detecting technique using UWB or ultrasonic waves that has been put to practical use in recent years.

### Solution to the Problem

According to a first aspect of the invention, there is provided a positional information analysis apparatus that analyzes, in real time, a state of a mobile station unit, which moves together with a detection target, obtained from continuous positional information of the mobile station unit. The positional information analysis apparatus according to the first aspect includes: a position detecting unit that calculates positional information which indicates a position of a mobile station unit; a positional information storage unit that stores the positional information calculated by the position detecting unit as a history for each of the mobile station unit; a state attribute calculating unit that calculates state attribute information which indicates the state of each of the mobile station unit from the history of the positional information of each of the mobile station unit each time the position detecting unit calculates the position of the mobile station unit; a meaning conversion rule storage unit that stores a first identifier which is given to a meaning of a movement of a mobile station unit and a rule which detects the meaning of the movement so as to associate the first identifier and the rule with each other; and a rule-positional information correlation calculating unit that determines whether the rule is matched on the basis of the positional information and the state attribute information of the mobile station unit and outputs the first identifier associated with the rule which is determined to be matched.

According to the first aspect, the positional information of the mobile station unit is acquired in real time and is then stored as the history. Then, the state attribute information indicating a movement of each mobile station unit or a relation of positions and movements between plural mobile station units are calculated in real time on the basis of the history information of the mobile station unit. Then, it is determined whether a predetermined rule is matched on the basis of the calculated positional information and the calculated state attribute information, and the first identifier associated with the rule that is determined to be matched is output. As such, since the positional information and the state attribute information of each mobile station unit are calculated in real time, it is possible to abstract information of each mobile station unit and thus reduce a load of rule processing. Therefore, it is possible to perform rule extracting processing in real time.

The rule-positional information correlation calculating unit may determine whether the rule is matched on the basis of the positional information and the state attribute information of the mobile station unit and further output a second identifier which identifies a mobile station unit which is determined to be matched with the rule.

The position detecting unit may calculate the positional information which indicates the position of the mobile station unit on the basis of position specification information which specifies the position of the mobile station unit received from a fixed station unit and positional information of the fixed station unit.

The positional information analysis apparatus according to the first aspect may further include a search information input unit to which search information is input. In this case, the rule-positional information correlation calculating unit may output the meaning of the movement of the mobile station unit which matches the search information as event information on the basis of the positional information and the state attribute information of the mobile station unit. As such, it is possible to input the search information to acquire desired information. In this case, the positional information and the state attribute information of each mobile station unit are calculated in real time. Therefore, it is possible to reduce a load of search processing and perform the search processing in real time.

The state attribute calculating unit may calculate movement attribute information which indicates a movement of each mobile station unit as the state attribute information. The state attribute calculating unit may calculate relation attribute information which indicates a relation of positions and movements between mobile station units. Since abstract state attribute information is generated from the positional information of each mobile station unit, it is possible to reduce a processing load which will be described below.

The rule-positional information correlation calculating unit may output the first identifier each time the position detecting unit calculates the position of the mobile station unit. In this way, it is possible to perform rule extracting processing and search processing in real time.

A notification information setting unit that converts the first identifier output from the rule-positional information correlation calculating unit into notification information which notifies a notification unit that accompanies the detection target may further be included. The notification unit may be the mobile station unit. In this way, it is possible to transmit the notification information considered from the meaning of the movement of the mobile station unit to the notification unit.

The positional information analysis apparatus according to the first aspect may further include: an advertisement display unit management unit that transmits advertisement information which corresponds to the first identifier output from the rule-positional information correlation calculating unit to an advertisement display unit which displays the advertisement information; and an advertisement display unit arrangement storage unit that stores a position of the advertisement display unit. In this case, the advertisement display unit management unit may select the advertisement display unit which is closest to the mobile station unit which corresponds to the rule associated with the first identifier, and transmit the advertisement information to the selected advertisement display unit. As such, since circumstances are acquired in real time, it is possible to effectively display an advertisement.

The position detecting unit may detect the position specification information of the mobile station unit using a high-accuracy detecting unit such as an impulse radio system. In this way, the positional information of the mobile station unit can be analyzed in real time.

According to a second aspect of the invention, there is provided a positional information analysis method that analyzes, in real time, a state of a mobile station unit, which moves together with a detection target, obtained from continuous positional information of the mobile station unit. The positional information analysis method includes: calculating positional information which indicates a position of a mobile station unit on the basis of position specification information which specifies the position of the mobile station unit, which is received from a fixed station unit, and positional information of the fixed station unit; storing the positional information calculated by a position detecting unit as a history for each mobile station unit; calculating state attribute information which indicates the state of each of the mobile station unit from the history of the positional information of each of the mobile station unit each time the position detecting unit calculates the position of the mobile station unit; and determining whether the rule which detects the meaning of the movement of the mobile station unit is matched on the basis of the positional information and the state attribute information of the mobile station unit and outputting a first identifier which is given to the meaning of the movement of the mobile station unit and is associated with the rule that is determined to be matched.

As such, since the positional information and the state attribute information of each mobile station unit are calculated in real time, it is possible to abstract information of each mobile station unit and thus reduce a load of rule processing. Therefore, it is possible to perform rule extracting processing in real time.

Here, the outputting the first identifier may include: determining whether the rule is matched on the basis of the positional information and the state attribute information of the mobile station unit; and outputting a second identifier which identifies the mobile station unit which is determined to be matched with the rule.

The calculating the positional information may include: calculating the positional information which indicates the position of the mobile station unit on the basis of position specification information which specifies the position of the mobile station unit received from the fixed station unit and the positional information of the fixed station unit.

The positional information analysis method according to the second aspect may further include acquiring search information. In this case, the outputting the first identifier may include outputting the meaning of the movement of the mobile station unit which matches the search information as event information on the basis of the positional information and the state attribute information of the mobile station unit. In this case, since the positional information and the state attribute information of each mobile station unit are calculated in real time, it is possible to reduce a load of search processing and perform search processing in real time.

For example, the calculating the state attribute information may include calculating movement attribute information which indicates the movement of each mobile station unit as the state attribute information. Since abstract state attribute information is generated from the positional information of each mobile station unit, it is possible to reduce a processing load which will be described below.

The outputting of the first identifier may include calculating the first identifier each time the position of the mobile station unit is calculated in the position detecting step. In this way, it is possible to perform rule extracting processing or search processing in real time.

The positional information analysis method according to the second aspect may further include: converting the output first identifier into notification information which notifies a notification unit that accompanies the detection target. In this way, it is possible to transmit the notification information considered from the meaning of the movement of the mobile station unit to the notification unit. In this case, the notification unit may be the mobile station unit. The positional information analysis method according to the second aspect may further include transmitting advertisement information which corresponds to the output first identifier to an advertisement display unit that displays the advertisement information. In this case, the transmitting the advertisement information may include: selecting the advertisement display unit which is closest to the mobile station unit which corresponds to the rule associated with the first identifier on the basis of the position of the advertisement display unit which is stored in an advertisement display unit arrangement storage unit; and transmitting the advertisement information to the selected advertisement display unit. As such, since circumstances are acquired in real time, it is possible to effectively display an advertisement.

The calculating of the positional information may include detecting the position specification information of the mobile station unit using a high-accuracy detecting unit such as an impulse radio system.

According to a third aspect of the invention, there is provided a positional information analysis system that analyzes a state of a mobile station unit, which moves together with a detection target, obtained from continuous positional information of the mobile station unit in real time. The positional information analysis system includes: a fixed station unit that outputs position specification information which specifies a position of a mobile station unit; and a positional information analysis apparatus that acquires meaning information of a movement of the mobile station unit on the basis of continuous positional information of the mobile station unit calculated from the position specification information. The fixed station unit includes a position specification information transmitting unit that transmits the position specification information which specifies the position of the mobile station unit to the positional information analysis apparatus. The positional information analysis apparatus includes: a position detecting unit that calculates positional information which indicates the position of the mobile station unit on the basis of the position specification information received from the fixed station unit and positional information of the fixed station unit; a positional information storage unit that stores the positional information calculated by the position detecting unit as a history for each mobile station unit; a state attribute calculating unit that calculates state attribute information which indicates the state of each mobile station unit from the history of the positional information of each mobile station unit each time the position detecting unit calculates the position of the mobile station unit; a meaning conversion rule storage unit that stores a first identifier which is given to a meaning of a movement of each mobile station unit and a rule which detects the meaning of the movement so as to associate the first identifier and the rule with each other; and a rule-positional information correlation calculating unit that determines whether the rule is matched on the basis of the positional information and the state attribute information of the mobile station unit and outputs the first identifier associated with the rule which is determined to be matched.

### EFFECTS OF THE INVENTION

As described above, it is possible to provide a positional information analysis apparatus, a positional information analysis method, and a positional information analysis system capable of acquiring positional information of a moving body with high accuracy and analyzing a meaning of a movement line of each moving body in real time from the movement line which is a transition in the positional information over time.

### BRIEF DESCRIPTION OF DRAWINGS

FIG. 1 is a block diagram illustrating the structure of a positional information analysis system according to a first exemplary embodiment of the invention.

FIG. 2 is a diagram illustrating content stored in a fixed station arrangement information storage unit according to the first exemplary embodiment.

FIG. 3 is a diagram illustrating content stored in a positional information storage unit according to the first exemplary embodiment.

FIG. 4 is a diagram illustrating content stored in a related information storage unit according to the first exemplary embodiment.

FIG. 5 is a diagram illustrating content stored in a meaning conversion rule storage unit according to the first exemplary embodiment.

FIG. 6 is a flowchart illustrating a positional information analysis method according to the first exemplary embodiment.

FIG. 7 is a diagram illustrating an example of data received by a position detecting unit of a positional information analysis apparatus from a fixed station unit.

FIG. 8 is a diagram illustrating an example of data transmitted from the position detecting unit to a positional information management unit in the positional information analysis apparatus.

FIG. 9 is a diagram illustrating an example of a state attribute information of a mobile station unit.

FIG. 10 is a diagram illustrating an example of meaning information indicating a meaning of a movement of a mobile station unit.

FIG. 11 is a block diagram illustrating a structure of an advertisement display device.

FIG. 12 is a diagram illustrating content stored in an advertisement display unit arrangement storage unit.

FIG. 13 is a flowchart illustrating a method of displaying an advertisement on the advertisement display unit.

FIG. 14 is a block diagram illustrating a modification of the positional information analysis system according to the first exemplary embodiment of the invention.

FIG. 15 is a block diagram illustrating a structure of a positional information analysis system according to a second exemplary embodiment of the invention.

FIG. 16 is a flowchart illustrating a positional information analysis method according to the second exemplary embodiment.

FIG. 17 is a block diagram illustrating a structure of a positional information analysis system according to a third exemplary embodiment of the invention.

FIG. 18 is a diagram illustrating content stored in a mobile communication unit correspondence storage unit according to the third exemplary embodiment.

FIG. 19 is a flowchart illustrating an information notifying method according to the third exemplary embodiment.

### BEST MODE FOR CARRYING OUT THE INVENTION

Hereinafter, exemplary embodiments of the invention will be described with reference to the accompanying drawings. In the specification and the drawings, components having substantially the same functional structures are denoted by the same reference numerals and a description thereof will not be repeated.

### First Exemplary Embodiment

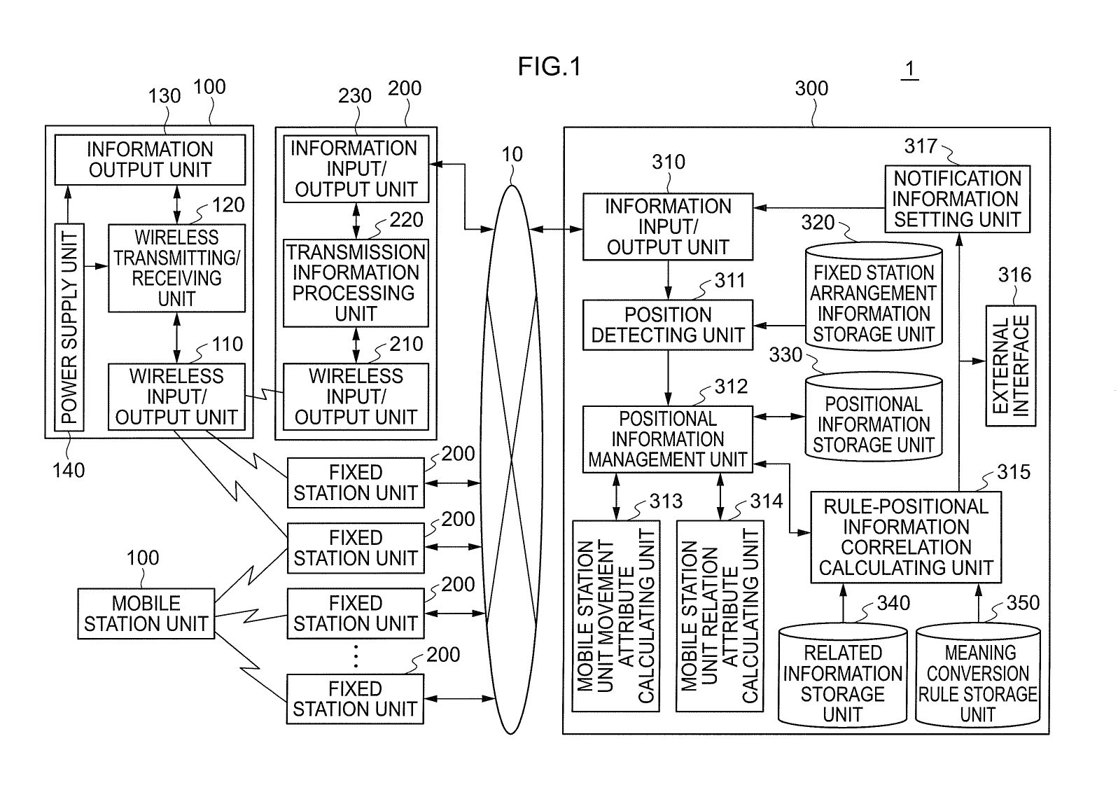

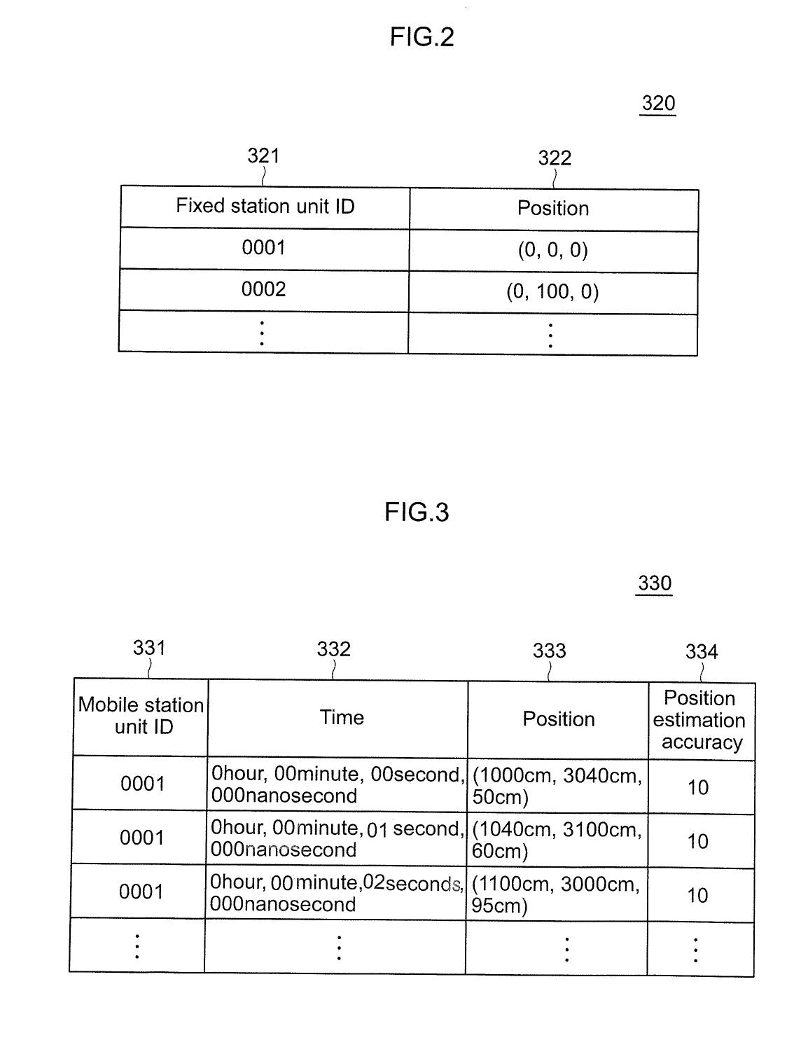

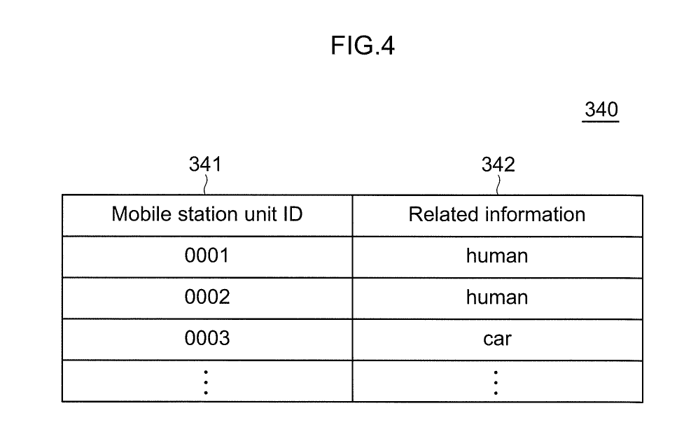

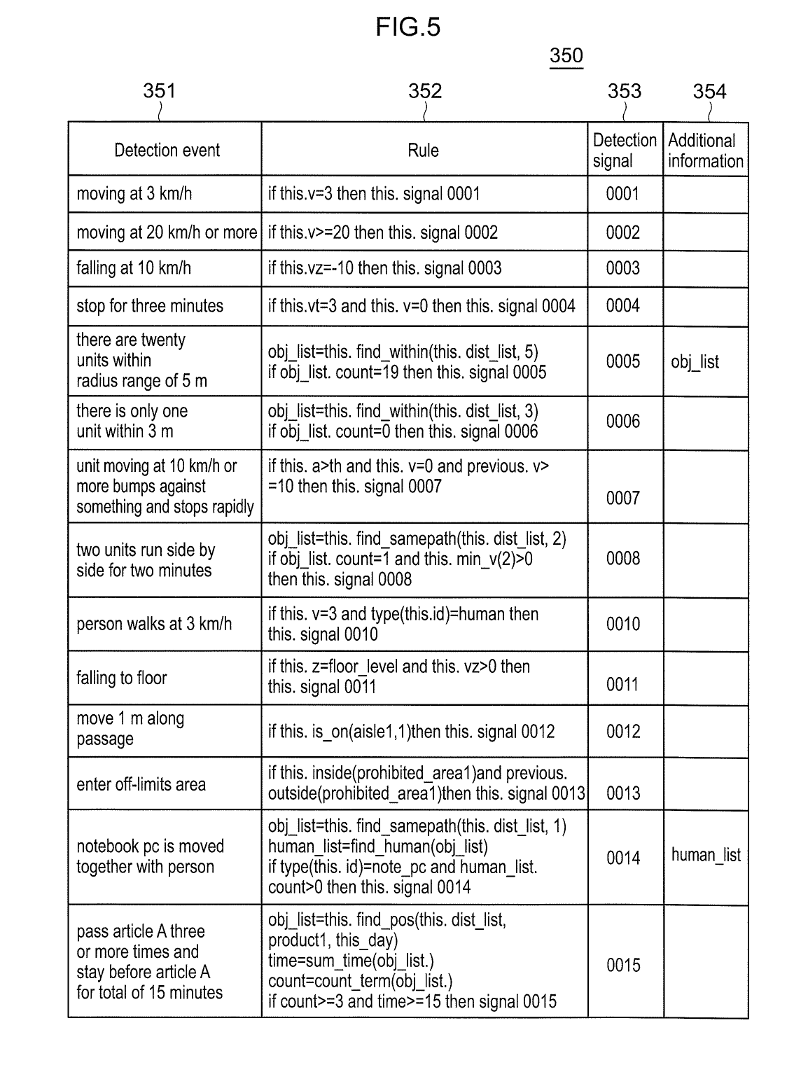

First, a positional information analysis system according to a first exemplary embodiment of the invention will be described with reference to FIGS. 1 to 5. FIG. 1 is a block diagram illustrating a structure of a positional information analysis system 1 according to this exemplary embodiment. FIG. 2 is a diagram illustrating content stored in a fixed station arrangement information storage unit 320 according to this exemplary embodiment. FIG. 3 is a diagram illustrating content stored in a positional information storage unit 330 according to this exemplary embodiment. FIG. 4 is a diagram illustrating content stored in a related information storage unit 340 according to this exemplary embodiment. FIG. 5 is a diagram illustrating content stored in a meaning conversion rule storage unit 350 according to this exemplary embodiment.

<Structure of Positional Information Analysis System>

As shown in FIG. 1, the positional information analysis system 1 according to this exemplary embodiment includes mobile station units 100 that moves together with persons or articles to be detected, fixed station units 200 that can communicate with the mobile station units 100, and a positional information analysis apparatus 300 that analyzes a state of a mobile station unit 100 obtained from continuous positional information of the mobile station unit 100 in real time, which are connected to each other through wireless communication or a network 10. The network 10 is, for example, an indoor local area network. The network 10 may be a wiring line that does not have an exchange function and connects the fixed station units 200 and the positional information analysis apparatus 300.

The mobile station unit 100 is a unit which moves together with a detection target. The mobile station unit 100 may be incorporated into, for example, a mobile communication terminal, or it may be formed such as a card holder type, a credit cart type, a watch type, a key holder type, an umbrella type, a hat type, a spectacle type, a body-implanted type, and a cloth attachment type, in terms of mobility. For example, the mobile station unit 100 includes a wireless input/output unit 110, a wireless transmitting/receiving unit 120, an information output unit 130, and a power supply unit 140. The wireless input/output unit 110 is a functional unit that performs wireless communication with a wireless input/output unit 210 of the fixed station unit 200 which will be described below. The wireless transmitting/receiving unit 120 is a functional unit that inputs a radio signal to the wireless input/output unit 110 and outputs the radio signal to the fixed station unit 200. The information output unit 130 is a functional unit that outputs information to the positional information analysis apparatus 300 through the fixed station unit 200. The power supply unit 140 is a functional unit that supplies power to the wireless transmitting/receiving unit 120 and the information output unit 130.

The fixed station unit 200 performs wireless communication with the mobile station unit 100 in order to measure the position with respect to the mobile station unit 100. The fixed station unit 200 includes the wireless input/output unit 210, a transmission information processing unit 220, and an information input/output unit 230. The wireless input/output unit 210 is a functional unit that performs wireless communication with the mobile station unit 100. The transmission information processing unit 220 is a functional unit that converts information exchanged between the mobile station unit 100 and the positional information analysis apparatus 300 into a predetermined format. The information input/output unit 230 is a functional unit that communicates with the positional information analysis apparatus 300.

For example, when the communication between the mobile station unit 100 and the fixed station unit 200 is performed by electrical waves, the mobile station unit 100 transmits, for example, a mobile station unit ID which identifies a mobile station unit 100 uniquely to the fixed station unit 200. Specifically, for example, the mobile station unit 100 may modulate electrical waves and transmit the mobile station unit ID to the fixed station unit 200. Alternatively, the mobile station units 100 may use different frequencies and the fixed station unit 200 may identify the used frequency to specify the mobile station unit ID. The fixed station unit 200 transmits the mobile station unit ID received from the mobile station unit 100 and an arrival time of the electrical wave from the mobile station unit 100 to the fixed station unit 200 to the positional information analysis apparatus 300. When a propagation time of the electrical wave, rather than a difference between the arrival times of the electrical waves, is measured, the propagation time of the electrical wave other than the arrival time may be output. In order to measure the propagation time of the electrical wave, any of the following methods may be used: a method of completely synchronizing the mobile station unit 100 with the fixed station unit 200 and subtracting a transmission time from a reception time; and a method of transmitting to reciprocate electrical waves between the mobile station unit 100 and the fixed station unit 200 and subtracting a processing time of at the mobile station unit 100 and the fixed station unit 200 from the transmission time required to transmit the electrical waves to and from the mobile station unit 100 and the fixed station unit 200 to obtain the half of the subtracted time. When the propagation time of the electrical wave is measured on the basis of, for example, radio field intensity, the arrival time of the electrical wave and the radio field intensity may be output.

The positional information analysis apparatus 300 analyzes the meaning of the movement of the mobile station unit 100 from the position and/or the movement of the mobile station unit 100, and includes an information input/output unit 310, a position detecting unit 311, a positional information management unit 312, a mobile station unit movement attribute calculating unit 313, a mobile station unit relation attribute calculating unit 314, a rule-positional information correlation calculating unit 315, an external interface 316, a notification information setting unit 317, a fixed station arrangement information storage unit 320, a positional information storage unit 330, a related information storage unit 340, and a meaning conversion rule storage unit 350.

The information input/output unit 310 is a functional unit that communicates with the fixed station unit 200 and is connected to the fixed station unit 200 through the network 10. The position detecting unit 311 is a functional unit that calculates the position of each mobile station unit 100 from the position of the fixed station unit 200 and the positional relationship between the mobile station unit 100 and the fixed station unit 200, with reference to the fixed station arrangement information storage unit 320 which will be described below. Specifically, for example, when electrical waves are used to measure the position of the mobile station unit 100, the position detecting unit 311 calculates the position of the mobile station unit 100 on the basis of the mobile station unit ID and the arrival time of the electrical wave received from the fixed station units 200, and the positional information of the fixed station units 200 stored in the fixed station arrangement information storage unit 320 which will be described below.

As a method of measuring a distance using electrical waves, any of the following methods is mainly used: a method of measuring the distance between the mobile station unit 100 and the fixed station unit 200 by the intensity of the electrical wave (RSSI: Received Signal Strength Indicator); a method of measuring the distance between the mobile station unit 100 and the fixed station unit 200 by the arrival time of the electrical waves (TOA: Time of Arrival); and a method of measuring the distance between the mobile station unit 100 and the fixed station unit 200 from the difference between the arrival times of the electrical waves (TDOA: Time Difference of Arrival). In all the measuring methods, the relative distance or the difference of the distance between two, or three or more fixed station units 200 and one mobile station unit 100 may be calculated by the radio field intensity or the propagation time of the electrical wave, and the position of the mobile station unit 100 may be calculated by, for example, trilateration. The calculated position of the mobile station unit 100 is a relative position to the fixed station unit 200. When the position is detected indoors, an indoor map and coordinate axes may be determined to calculate the coordinates of the position of the mobile station unit 100 indoors by the position of the fixed station unit 200.

For example, in a method of estimating the position of the mobile station unit from the intensity of electrical waves, using a conventional wireless technique, such as IEEE802.11a/b/g standard or IEEE802.15.4 standard, it is difficult to estimate the position due to the influence of reflected waves. In a path from the transmission of electrical waves to the reception thereof, a linear wave that is linearly transmitted has the shortest wavelength, and a reflected wave that is reflected at a wall and the like while being transmitted has a long wavelength. At a receiver side, a composite wave of the direct wave and the reflected wave is received. Therefore, it is difficult to separate only the intensity of the direct wave from the intensity of the electrical waves, and the intensity of direct wave is likely to be attenuated while being transmitted. As such, it is very difficult to estimate the distance, and the accuracy of estimation of the position is about several meters. When the position of the mobile station unit is estimated by the arrival time of the electrical wave, the estimation of the position is likely to be affected by fading in a conventional wireless system, such as IEEE802.11a/b/g standard or IEEE802.15.4 standard. In addition, since carrier waves are used, it is difficult to clearly specify the start position of electrical waves, and the accuracy of estimation of the position is equal to or more than about 2 m to 3 m at the most.

However, in this exemplary embodiment, an impulse radio system using a very short pulse wave is used. Therefore, even when the pulse waves are combined with reflected waves, it is possible to easily separate a direct wave pulse and thus detect the arrival time of the direct wave with high accuracy. The arrival time is measured as follows. For example, the fixed station unit 200 transmits an electrical wave to the mobile station unit 100, and the mobile station unit 100 receiving the electrical wave from the fixed station unit 200 transmits the electrical wave to the fixed station unit 200. In this way, the fixed station unit 200 can acquire the total time ts (=tw+ta) of the time tw required for the electrical wave to reciprocate and the processing time to of the mobile station unit 100. The processing time tw of the mobile station unit 100 can be acquired by a built-in counter in the information output unit 130. The fixed station unit 200 can acquire the processing time tw from the mobile station unit 100 via wireless communication. The fixed station unit 200 subtracts the processing time tw received from the mobile station unit 100 from the total time ts and divides the time by half, thereby obtaining the one-way arrival time (ts−tw)/2 of the electrical wave. It is possible to calculate the distance between the mobile station unit 100 and the fixed station unit 200 by the calculated one-way arrival time of the electrical wave and the speed of the electrical wave which has been known as the speed of light.

When the mobile station unit 100 does not have a function of transmitting electrical waves, a method of using the difference between the arrival times of the electrical waves (TDOA) may be used to measure the position of the mobile station unit 100. In this case, it is possible to calculate the position of the mobile station unit 100 by acquiring the difference between the arrival times of the electrical waves by the differences between the times when the fixed station units 200 receive the electrical waves transmitted from the mobile station unit 100.

The position detecting unit 311 may output an amount of errors in the calculation of the position of the mobile station unit 100 as estimation accuracy. For example, when information acquired from a large number of fixed station units 200 is used, it is possible to detect the direct waves transmitted through various paths. In this case, the information acquired from the fixed station unit 200 that is regarded to have many errors is neglected. In this way, it is possible to perform estimation with higher accuracy than in a case it is impossible to receive the information of the mobile station unit 100 from the fixed station unit 200 with little errors.

As such, the position detecting unit 311 calculates the position of each mobile station unit 100 and outputs the calculated position to the positional information management unit 312 which will be described below.

The positional information management unit 312 is a functional unit that manages the positional information of each of the mobile station units 100 and the positional relationship between the mobile station units 100 and updates the positional information, on the basis of the histories of the positional information of the mobile station units 100. The positional information management unit 312 stores the positional information of each mobile station unit 100 received from the position detecting unit 311 as the history in the positional information storage unit 330. In addition, the positional information management unit 312 transmits the history of the positional information of each mobile station unit 100 stored in the positional information storage unit 330 to the mobile station unit movement attribute calculating unit 313 and the mobile station unit relation attribute calculating unit 314 which will be described below. The positional information management unit 312 stores the movement attribute information of each mobile station unit 100 received from the mobile station unit movement attribute calculating unit 313 and the relation attribute information between the mobile station units 100 received from the mobile station unit relation attribute calculating unit 314 in the positional information storage unit 330.

The mobile station unit movement attribute calculating unit 313 is one of a state attribute information calculating unit that calculates the state attribute information of the mobile station unit 100, and is a functional unit that calculates the movement of each mobile station unit 100 on the basis of the history of the positional information of each mobile station unit 100. The movement attribute information of the mobile station unit 100 indicates the movement of each mobile station unit 100, and means an attribute, such as a speed at a specific time or a traveling direction. Specifically, the movement attribute information includes: a mobile station unit ID, time, a position, and an estimation accuracy of position included in data output from the detecting unit 311; an X-direction speed, a Y-direction speed, and a Z-direction speed, which are speeds in the X-axis direction, the Y-axis direction, and the Z-axis direction; a movement speed in the traveling direction, for example, the clockwise direction when the Y axis is 0°, a speed of the mobile station unit 100, an acceleration speed, and a rotational speed; and a uniform motion time for which a moving body moves at a uniform velocity within an error range of β%. The movement attribute information of each mobile station unit 100 calculated by the mobile station unit movement attribute calculating unit 313 is transmitted to the positional information management unit 312, and is then stored in the positional information storage unit 330 together with the positional information of the mobile station unit 100.

The mobile station unit relation attribute calculating unit 314 is one of the state attribute information calculating unit that calculates the state attribute information of the mobile station unit 100, and is a functional unit that calculates the relation attribute information between the mobile station units 100 on the basis of the histories of the positional information of mobile station units 100. For example, the mobile station unit relation attribute calculating unit 314 makes a list of the mobile station unit IDs of the mobile station units 100 which are arranged in the vicinity of the mobile station unit 100 to be detected in order of distances from the mobile station unit 100 to be detected such that the mobile station unit ID of the mobile station unit 100 arranged closest to the mobile station unit 100 to be detected has the highest rank. Then, the mobile station unit relation attribute calculating unit 314 updates the list of the mobile station unit IDs in order of the distances each time the position detecting unit 311 acquires new positional information of the mobile station unit 100.

In addition, the mobile station unit relation attribute calculating unit 314 makes a list of the mobile station unit IDs of the mobile station units 100 in order of approach time which indicates the total sum of time while a mobile station unit 100 is within a distance range of a such that the mobile station unit ID of the mobile station unit 100 with the longest approach time has the highest rank. For example, when a mobile station unit 100A and a mobile station unit 100B are adjacent to each other for 2 minutes within a distance range of α, the approach time is 2 minutes. The mobile station unit relation attribute calculating unit 314 updates the list of the mobile station unit IDs in order of the approach time each time the position detecting unit 311 acquires new positional information of the mobile station units 100.

The list of the mobile station unit IDs in order of the distance or the approach time which is calculated by the mobile station unit relation attribute calculating unit 314 is transmitted to the positional information management unit 312 and is then stored in the positional information storage unit 330 together with the positional information of each mobile station unit 100.

The rule-positional information correlation calculating unit 315 is a functional unit that matches the rule stored in the meaning conversion rule storage unit 350 which will be described below with the positional information, the movement attribute information, and the relation attribute information of the mobile station unit 100 and converts the positional information of the mobile station unit 100 into the meaning of the movement.

For example, ‘the meaning of the movement’ of the mobile station unit 100 acquired by the rule-positional information correlation calculating unit 315 includes the movement of a single mobile station unit 100, such as ‘walking at 3 km/h’, ‘running at 20 km/h’, ‘falling at 10 km/h’, and ‘stop for 3 minutes’ in a case of a person, as well as a relation with another mobile station unit 100, such as ‘there are twenty persons within a radius of 5 m’, ‘there is no person within a radius of 3 m’, ‘the person who runs at 10 km/h bumps against something and stops rapidly’, and ‘two persons run side by side for two minutes’. In addition, the meaning of the movement of the mobile station unit 100 may be represented by associating an event, such as ‘falling to the floor’ and ‘moving along the passage’, with the positional information of the mobile station unit 100 or time as a relation with a surrounding environment.

The meaning of the movement of the mobile station unit 100 may be represented by a combination with an event other than a movement line. For example, in a method of estimating the degree of interest of a person in an article from the relationship between the position of the article and the position of the person, the following events may be given as an example: ‘when a person passes the same article ten times, the person takes an interest in the article’, ‘when a movement speed of a person before a specific article is lowered, the person takes a little interest in the article’, ‘when the degree of congestion before a specific article was high, but is lowered after a predetermined amount of time has elapsed, the article is sold out’, and ‘when a person slowly approaches and rapidly passes the place in which the degree of congestion before a specific article was high, but is lowered after a predetermined amount of time has elapsed, the person takes an interest in the article but cannot purchase the article to which the person feels regret since the article is sold out’. In an example of the management of articles, in terms of security, the following events may be defined: ‘when a notebook PC moves together with the owner thereof, the owner with the notebook PC moves’; and ‘when the notebook PC moves but the owner thereof does not move, the notebook PC is likely to be illegally taken out’.

The meaning of the movement of the mobile station unit 100 is output as meaning information from the rule-positional information correlation calculating unit 315 to the external interface 316 and the notification information setting unit 317. The output meaning information may be, for example, a detection signal, which is a first identifier (an identifier stored in the meaning conversion rule storage unit 350, which will be described below, so as to be associated with the meaning of the movement) given to each meaning of movement, or it may be the meaning of the movement of the mobile station unit 100. The rule-positional information correlation calculating unit 315 according to this exemplary embodiment performs processing each time the positional information of the mobile station unit 100 is updated.

The external interface 316 is a functional unit that outputs the meaning information of the mobile station unit 100 received from the rule-positional information correlation calculating unit 315 to the outside. For example, a display device, such as a display, or an advertisement display device, which will be described below, may be connected to the external interface 316.

The notification information setting unit 317 is a functional unit that generates information to be notified to the mobile station unit 100 from the meaning information of the mobile station unit 100 received from the rule-positional information correlation calculating unit 315 and outputs the notification information to the mobile station unit 100 through the network 10. For example, when meaning information associated with a detection signal ‘0002 ’ is input from the rule-positional information correlation calculating unit 315 to the notification information setting unit 317 in a place where running is prohibited, a message ‘excess of speed limits’ may be transmitted to the mobile station unit 100 having the meaning information through the network 10. For example, when meaning information associated with a detection signal ‘0014 ’ is input from the rule-positional information correlation calculating unit 315 to the notification information setting unit 317, the mobile station unit ID of the person who is moving and a message ‘being transported’ may be displayed on the mobile station unit 100 of the notebook PC.

The fixed station arrangement information storage unit 320 is a storage unit that stores the position of the fixed station unit 200 and includes a memory, such as a RAM or a hard disk. As shown in FIG. 2, the fixed station arrangement information storage unit 320 stores a fixed station unit ID 321 that specifies the fixed station unit 200 and the position 322 of the fixed station unit 200 so as to associate them with each other.

The positional information storage unit 330 is a storage unit that stores the history of the positional information of each mobile station unit 100, the movement attribute information of each mobile station unit 100, and the relation attribute information between the mobile station units, and includes a memory, such as a RAM or a hard disk. As shown in FIG. 3, the positional information storage unit 330 stores as the history of the positional information of each mobile station unit 100 a mobile station unit ID 331 that specifies the mobile station unit 100, time 332, the position 333 of the mobile station unit 100, and position estimation accuracy 334 so as to associate them with each other. In addition, although not shown in the drawings, the positional information storage unit 330 stores the movement attribute information of each mobile station unit calculated by the mobile station unit movement attribute calculating unit 313 and the relation attribute information between the mobile station units calculated by the mobile station unit relation attribute calculating unit 314 so as to associate them with the mobile station unit ID for each time.

The related information storage unit 340 is a storage unit that stores an attribute related to the mobile station unit 100 and includes a memory, such as a RAM or a hard disk. As shown in FIG. 4, the related information storage unit 340 stores, for example, a mobile station unit ID 341 and related information 342 so as to associate them with each other. The related information 342 shown in FIG. 4 includes the kind of person/article (for example, humans, animals, and cars) that moves together with the mobile station unit 100.

The meaning conversion rule storage unit 350 is a storage unit that stores the position or the movement of each mobile station unit 100 and the meaning of the movement so as to associate them with each other, and includes a memory, such as a RAM or a hard disk. As shown in FIG. 5, the meaning conversion rule storage unit 350 stores a detection event 351 that indicates the meaning of the movement of the mobile station unit 100, a rule 352 for detecting the detection event 351, a detection signal 353 serving as a first identifier that specifies the detection event 351, and additional information 354 so as to associate them with each other.

The rule 352 shown in FIG. 5 is an example. In FIG. 5, “this” is an object indicating the mobile station unit 100 whose positional information is a detection target, and “xxx” of “this.xxx” indicates processing or an attribute of the mobile station unit 100 to be detected. In addition, “this.signal” indicates processing for outputting the detection signal 353. For example, when ‘moving at 3 km/h’ is detected, the rule 352 defines that a speed attribute v of the mobile station unit 100 needs to satisfy 3 km/h when the positional information is calculated, and the detection signal ‘0001 ’ indicates the detection event 351. Similarly, when ‘moving at 20 km/h or more’ is detected, the rule 352 defines that the speed attribute v of the mobile station unit 100 needs to satisfy 20 km/h or more when the positional information is calculated, and the detection signal ‘0002 ’ indicates the detection event 351.

When ‘falling at 10 km/h’ is detected, the rule 352 defines that the speed of the mobile station unit 100 in the vertical direction (a speed vz in the z-axis direction) needs to satisfy falling to the ground at 10 km/h when the positional information is calculated, and a detection signal ‘0003 ’ indicates the detection event 351. When ‘stop for three minutes’ is detected, the rule 352 satisfies that the speed of the mobile station unit 100 is zero when the positional information is calculated and this state is maintained for three minutes, and a detection signal ‘0004 ’ indicates the detection event 351.

When ‘there are twenty units within a radius of 5 m’ is detected, a list (obj_list) of the mobile station units arranged within a distance range of 5 m from a target mobile station unit 100 is acquired (find_within) in order of the distance from the target mobile station unit when the positional information is calculated, and the rule 352 defines that the number of elements (obj_list.count) in the list needs to be 19 (20 elements including the mobile station unit 100 that is being subjected to the rule processing). A detection signal ‘0005 ’ indicates the detection event 351. A find_within process designates the list of the mobile station units 100 to a first parameter, designates a detection distance range to a second parameter, and returns a list of the mobile station units 100 that are within the distance range of the second parameter.

When ‘there is no unit within a distance range of 3 m’ is detected, a list (obj_list) of the mobile station units arranged within the distance range of 3 m from a target mobile station unit 100 is acquired (find_within) in order of the distance from the target mobile station unit when the positional information is calculated, and the rule 352 defines that the number of elements (obj_list.count) in the list needs to be zero. A detection signal ‘0006 ’ indicates the detection event 351. When ‘a unit that moves at 10 km/h or more bumps against something and stops rapidly’ is detected, the rule 352 defines that the speed v of the mobile station unit 100 needs to be zero when the positional information is calculated, the absolute value of acceleration needs to be equal to or more than a threshold value th, and the speed (previous.v) of the previous positional information (previous) needs to be equal to or more than 10 km/h. A detection signal ‘0007 ’ indicates the detection event 351.

When ‘two units run side by side for two minutes’ is detected, a list of the mobile station units that move through the same path for two minutes is acquired (find_samepath) when the positional information is calculated, and the rule 352 defines that the number of mobile station units that moves through the same path needs to be one and the minimum speed (min_v) for previous two minutes needs to be higher than zero. A detection signal ‘0008 ’ indicates the detection event 351. A find_samepath process designates a list of the mobile station units 100 to the first parameter, designates the previous time range to the second parameter, and returns a list of the mobile station units 100 that moves through the same path within the time range of the second parameter. A min_v processing designates the previous time range to the first parameter, and detects and returns the minimum speed of the mobile station unit 100 that is being subjected to the rule processing within the range designated by the second parameter.

In addition, information stored in other related databases may be included in the rule. For example, the related information storage unit 340 in which the mobile station unit ID and the kind of person/article that moves together with the mobile station unit 100 are stored so as to be associated with each other may be used. In this case, for example, a method (type(id)) of acquiring the kind of person/article from the mobile station unit ID (id) may be used to detect the detection event 351 ‘a person walks at 3 km/h’ indicated by a detection signal ‘0010 ’.

In addition, for example, the relationship with a structure or an article may be detected. For example, when the height of the floor in the Z direction is defined as “floor level”, the speed v and the position z of the mobile station unit 100 in the vertical direction may be used to define the detection event ‘falling to the floor’ indicated by a detection signal ‘0011 ’ as the rule 352. When the size and direction of a passage are defined as “aisle1”, the detection event ‘moving 1 m along the passage’ indicated by a detection signal ‘0012 ’ may be defined as the rule 352 that compares the movement of the mobile station unit 100 along the aisle1 with the history of the positional information.

When an off-limits area is defined as “prohibited_area1”, a detection event ‘enter an off-limits area’ indicated by a detection signal ‘0013’ defines the entrance of the mobile station unit 100 into the off-limits area as the rule 352 by a combination with information indicating that the mobile station unit 100 was disposed outside the off-limits area (outside) in the past, but is currently disposed inside the off-limits area (inside). In the case of a rectangular, the term ‘area’ can be represented by the coordinates of apexes of two corners. In the case of a circle, the term ‘area’ can be represented by, for example, the coordinates of the center and the radius thereof. In addition, the term ‘area’ may be defined as an enclosed space with any arbitrary shape. When the type of notebook personal computer is defined as “note_pc”, a detection event ‘a notebook personal computer is moving together with a person’ indicated by a detection signal ‘0014’ may be defined as the rule 352 by processing (find_human) that generates a list of humans from the list of the mobile station unit IDs.

When the position of an article A is defined as “product1”, a detection event ‘a person passes the article A three or more times and stays before the article A for a total of 15 minutes or more’ indicated by a detection signal ‘0015’ may be defined as the rule 352 that processing (find_pos) of detecting a history list of the mobile station unit 100 that passes the position of the article A at the same day is performed to calculate the sum of the times (sum_time) of the history list and the number of times (count_term) the mobile station unit 100 passes the same position from the history list.

As such, the meaning conversion rule storage unit 350 stores the detection event 351 indicating the meaning of the movement of the mobile station unit 100, the rule 352 correlated with the detection event 351, and the detection signal 353 for specifying the detection event 351 so as to associate them with each other.

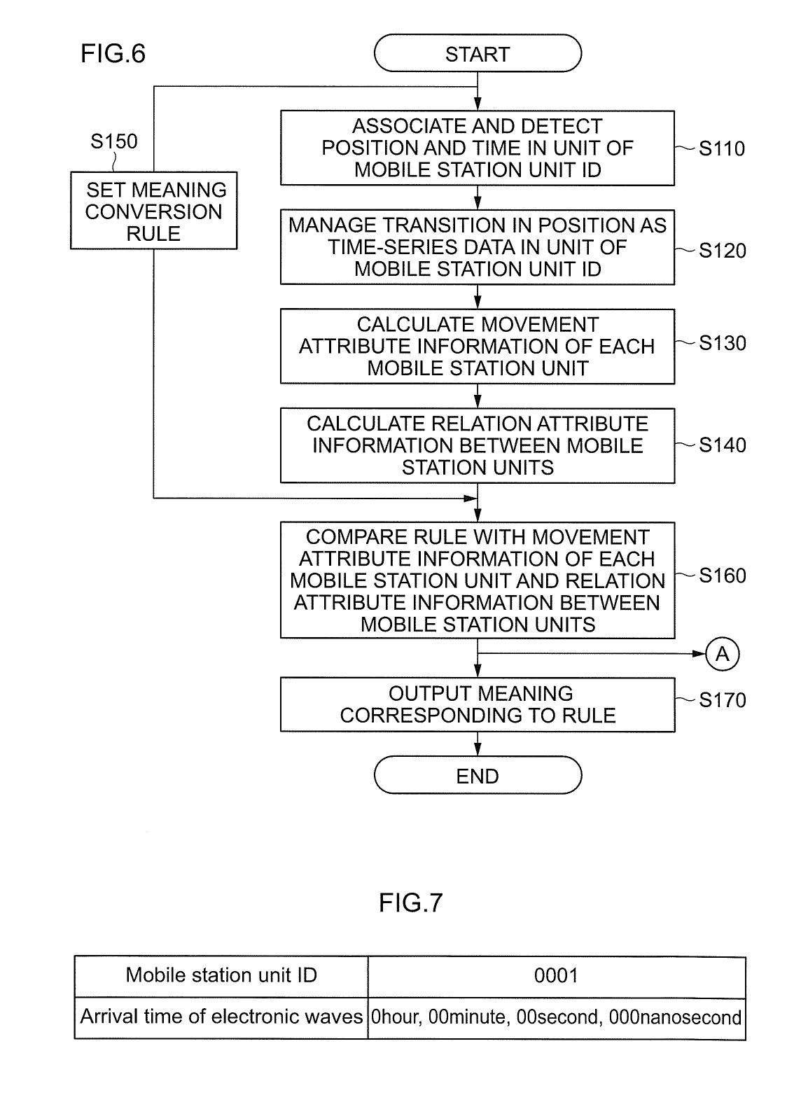

The structure of the positional information analysis system 1 according to this exemplary embodiment has been described with reference to FIGS. 1 to 5. Next, a method of analyzing the positional information of the mobile station unit 100 according to this exemplary embodiment will be described with reference to FIG. 6. FIG. 6 is a flowchart illustrating the positional information analysis method according to this exemplary embodiment.

<Method of Analyzing Positional Information>

As shown in FIG. 6, in the method of analyzing the positional information of the mobile station unit 100 according to this exemplary embodiment, first, the position and time of the mobile station unit 100 are detected in association with each other for each mobile station unit ID (S110). In Step S110, the position detecting unit 311 of the positional information analysis apparatus 300 receives the position specification information of the mobile station unit 100 and the arrival time of the electrical wave, which are accurately detected by, for example, an impulse radio system shown in FIG. 7, from the fixed station unit 200, and calculates the positional information of the mobile station unit 100. The positional information of the mobile station unit 100 is calculated by the above-mentioned method. The positional information of the mobile station unit 100 is detected periodically, for example, at an interval of 1 second, or continuously.

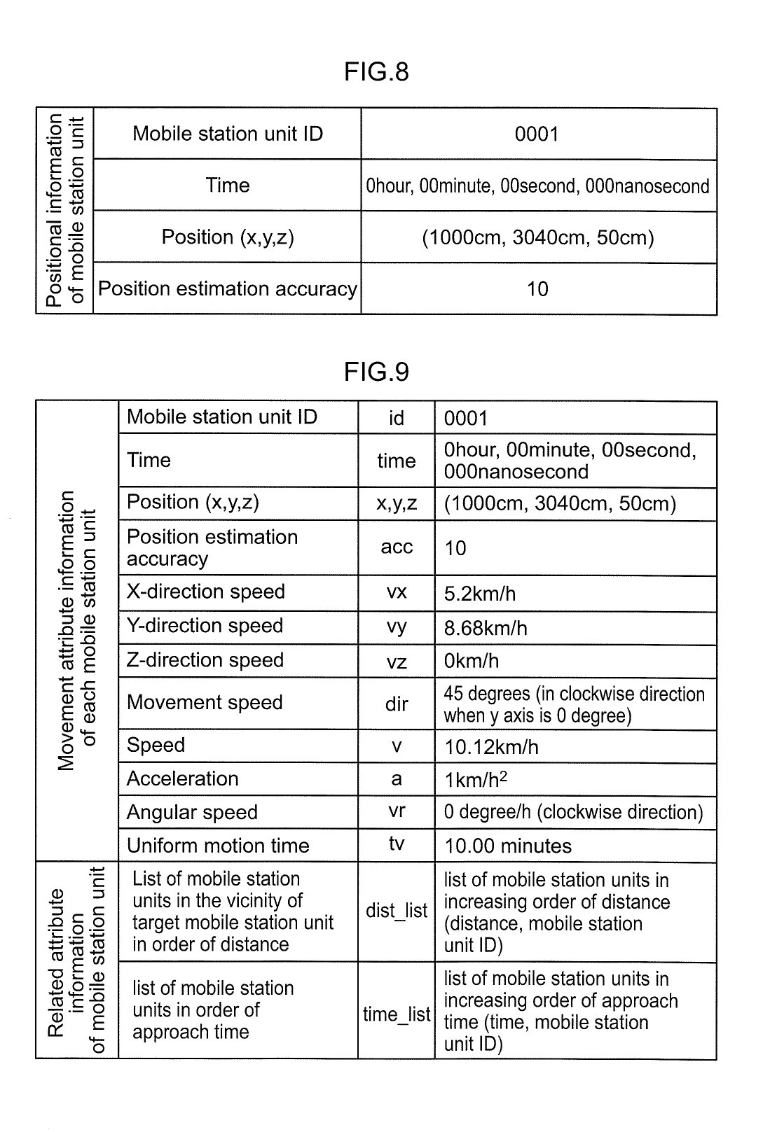

Then, a transition of the position of the mobile station unit 100 is managed as time-series data for each mobile station unit ID (S120). The position detecting unit 311 that has calculated the positional information of the mobile station unit 100 in Step S110 transmits the positional information of the mobile station unit 100 shown in FIG. 8 to the positional information management unit 312. The positional information of the mobile station unit 100 includes, for example, a mobile station unit ID, time, a position, and position estimation accuracy. The positional information management unit 312 stores the positional information as a history in the positional information storage unit 330, and manages transition information of the position of the mobile station unit 100, that is, the movement line.

The movement attribute information of each mobile station unit is calculated on the basis of the positional information of the mobile station unit 100 (S130). In Step S130, as shown in FIG. 9, the mobile station unit movement attribute calculating unit 313 calculates, for example, a mobile station unit ID, time, a position, position estimation accuracy, an X-direction speed, a Y-direction speed, a Z-direction speed, a movement direction, a speed, acceleration, an angular velocity, and a uniform motion time from the positional information of each mobile station unit 100. The movement attribute information is calculated each time the position of the mobile station unit 100 is detected.

Then, the relation attribute information between the mobile station units is calculated on the basis of the positional information of the mobile station unit 100 (S140). In Step S140, as shown in FIG. 9, the mobile station unit relation attribute calculating unit 314 calculates, for example, a list of the mobile station units arranged in the vicinity of a target mobile station unit in order of the distance therefrom and a list of the mobile station units in order of the approach time from the positional information of each mobile station unit 100. The relation attribute information is calculated each time the position of the mobile station unit 100 is detected.

State attribute information (in this exemplary embodiment, the movement attribute information and the relation attribute information) indicating the state of each mobile station unit, which is calculated in Step S130 and Step S140, is abstract information of the positional information, and is calculated each time the positional information is acquired in order to reduce the load of the rule processing of the rule-positional information correlation calculating unit 315. The attributes that are required in the rule processing all the time and are effective to be processed during the update of the positional information may be sequentially calculated.

Meanwhile, a rule such as the time-series pattern of a transition of the position of the mobile station unit 100 is defined for each meaning of the movement of the mobile station unit 100 that is desired to be detected in real time (S150). The meaning of the movement of the mobile station unit 100 that is desired to be detected is stored as a detection event in the meaning conversion rule storage unit 350 in advance so as to be associated with the rule correlated with the detection event.

Then, the movement attribute information of each mobile station unit and the relation attribute information between the mobile station units are compared with the rule (S160). The comparison in Step S160 is performed by the rule-positional information correlation calculating unit 315 on the basis of whether the movement attribute information of each mobile station unit and the relation attribute information between the mobile station units are matched with the rule 352 shown in FIG. 5. This processing may be performed each time the position of the mobile station unit 100 is detected. Alternatively, for example, any of the following methods may be used: a method of starting rule processing after the time designated in the rule processing, such as a timer event, has elapsed; and a method of performing the processing at a predetermined time interval. In addition, a state margin may be used to configure advanced rules.

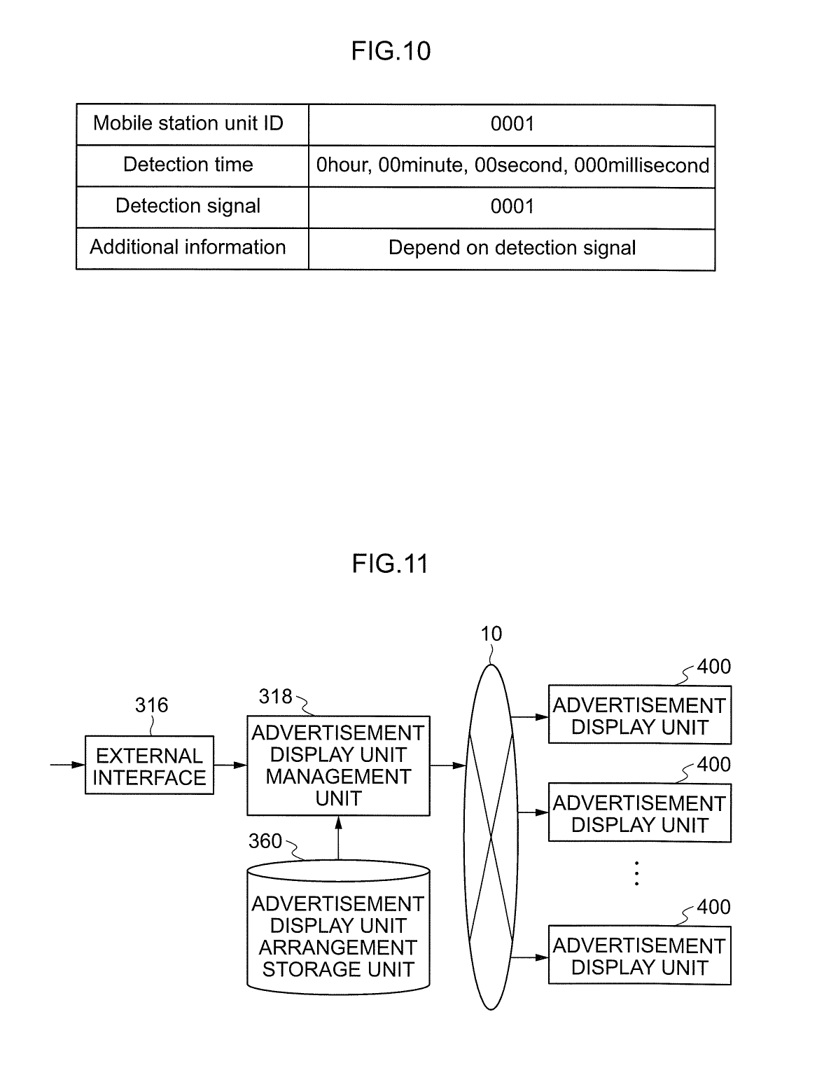

When the movement attribute information of each mobile station unit and the relation attribute information between the mobile station units are matched with the rule 352, the meaning information of the movement associated with the rule 352 is output in real time (S170). The output meaning information includes, for example, a mobile station unit ID, a detection time indicating the time when the positional information matched with the rule is detected, a detection signal, and additional information that is added to the detection signal and is used to indicate the meaning, which is shown in FIG. 10. On the other hand, when the movement attribute information of each mobile station unit and the relation attribute information between the mobile station units are not matched with the rule 352, the meaning information is not output.

The positional information analysis method according to this exemplary embodiment has been described above. When the above-mentioned processing is performed each time the position of the mobile station unit is detected, it is possible to detect the movement of each mobile station unit and the meaning of the movement of a group of the mobile station units in real time. Therefore, it is possible to perform processing corresponding to the detected meaning in real time.

Advertisement Display Device>

An advertisement display device shown in FIG. 11 may be connected to the positional information analysis apparatus 300 according to this exemplary embodiment. As shown in FIG. 11, the advertisement display device according to this exemplary embodiment includes an advertisement display unit management unit 318 and an advertisement display unit arrangement storage unit 360, and is connected to one or two or more advertisement display units 400 through the network 10. The advertisement display unit 400 is, for example, a display unit, such as a display, that displays an advertisement.

The advertisement display unit management unit 318 is a functional unit that determines the advertisement display unit 400 for displaying an advertisement, and is connected to the external interface 316. The advertisement display unit management unit 318 receives the positional information of the mobile station unit 100 from the external interface 316, determines the advertisement display unit 400 that displays an advertisement on the basis of the positional information, and transmits display content to the determined advertisement display unit 400 through the network 10.

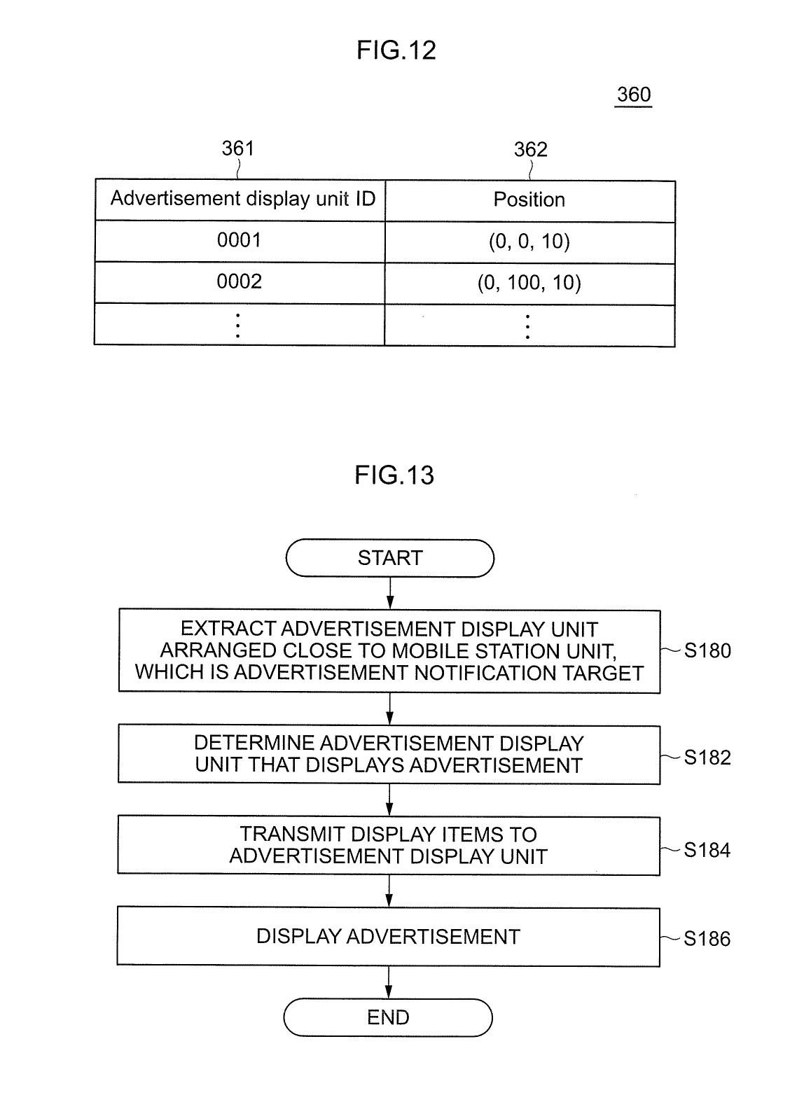

The advertisement display unit arrangement storage unit 360 is a storage unit that stores the position of the advertisement display unit 400, and includes a memory, such as a RAM or a hard disk. As shown in FIG. 12, the advertisement display unit arrangement storage unit 360 stores an advertisement display unit ID 361 for specifying the advertisement display unit 400 and the position 362 of the advertisement display unit so as to associate them with each other.

Next, a method of displaying an advertisement on the advertisement display unit 400 will be described with reference to FIG. 13. First, as shown in FIG. 13, the advertisement display unit 400 arranged nearby the mobile station unit 100, which is an advertisement notification target, is extracted (S180). The advertisement display unit 400 may be extracted as follows. For example, the positional information of the mobile station unit 100, which is an advertisement notification target, is compared with the position of the advertisement display unit 400 stored in the advertisement display unit arrangement storage unit 360, and the advertisement display unit 400 positioned within a predetermined range is extracted on the basis of the comparison result.

Then, the advertisement display unit 400 that displays an advertisement is determined (S182). The advertisement display unit management unit 318 determines the advertisement display unit 400 that displays an advertisement among the advertisement display units 400 extracted in Step S180. The advertisement display unit 400 may be determined as follows. For example, the advertisement display unit 400 that is arranged in an area in which the mobile station unit 100 moves is selected, or a predetermined number of advertisement display units 400 are selected, in consideration of the movement direction of the mobile station unit 10.

Then, display item is transmitted to the advertisement display unit 400 (S184). The display item may include, for example, meaning information associated with the detection signal calculated by the rule-positional information correlation calculating unit 315 and information to be notified to the mobile station unit 100, which is an advertisement notification target, from the meaning information. The advertisement display unit management unit 318 transmits the display item to the advertisement display unit 400 that displays an advertisement through the network 10. When receiving the display item, the advertisement display unit 400 displays the display item as an advertisement (S186).

For example, when the rule-positional information correlation calculating unit 315 calculates the detection event ‘a person passes the article A three or more times and stays before the article A for a total of 15 minutes or more’ indicated by the detection signal ‘0015 ’, information indicating that ‘the owner of a mobile station unit ID hesitates about purchasing the article A before the article’ may be transmitted to another mobile station unit 100 having the attribute of a clerk, or other information display terminal through the external interface 316. In addition, the advertisement display unit management unit 318 connected to the external interface 316 may instruct the advertisement display unit 400 that is arranged nearby the mobile station unit 100, which is a notification target, to display information which leads the person to purchase the article A.

For example, it is assumed that a customer has the mobile station unit 100 in a supermarket and the advertisement display units 400 arranged at various positions in the supermarket are connected to the advertisement display unit management unit 318 and the external interface 316 through the network 10. In this case, when the movement speed of the customer is lowered before a specific shelf, it may be estimated that the customer takes an interest in an article on the shelf. When the customer stops before the shelf, it may be estimated that the customer hesitates about purchasing the article. Each customer is specified on the basis of the information and the interest of the customer in the article is estimated from the movement. Then, information related to the article on the shelf is displayed on the advertisement display unit 400 in an appropriate form. In this way, it is possible to improve the effects of advertisements.

The positional information analysis system 1 according to the first exemplary embodiment of the invention has been described above. According to the positional information analysis system 1 of this exemplary embodiment, the positional information of each mobile station unit 100 is detected and managed as history information, and the movement attribute information of each mobile station unit 100 and the relation attribute information between the mobile station units 100, which are the state attribute information of the mobile station unit 100, are calculated on the basis of the positional information. Then, the meaning information of the movement of the mobile station unit 100 is acquired on the basis of the meaning of the predetermined movement, the rule for detecting the meaning of the movement, the positional information, and the state attribute information. In this exemplary embodiment, it is possible to accurately detect movement, which is a transition pattern of the positional information over time, from the high-accuracy positional information of the mobile station unit 100, and thus detect association between the movements of the mobile station units 100. In this way, it is possible to detect the positional information of the mobile station unit 100, the movement of the mobile station unit 100, and the relation with other mobile station unit in real time. In addition, it is possible to individually or collectively detect various movements of individuals in real time by describing the meaning of the movement or the relation as the rule.

Since the advertisement display device is connected to the external interface 316, it is possible to estimate the meaning of movement, such as the degree of interest, from the position and movement of the mobile station unit 100 and effectively display an advertisement.

The positional information analysis system 1 according to this exemplary embodiment can detect the movement of the mobile station unit 100 in real time. Therefore, the positional information analysis system 1 may be appropriate for usage purpose as a security system. For example, an event ‘a person who stays with an employee is not detected, but a person who is alone is detected’ may be detected. In addition, the positional information analysis system may cooperate with another monitoring camera and the monitoring camera may detect a moving body that is disposed at a position where the positional information does not exist (that is, where the mobile station unit 100 is not provided).

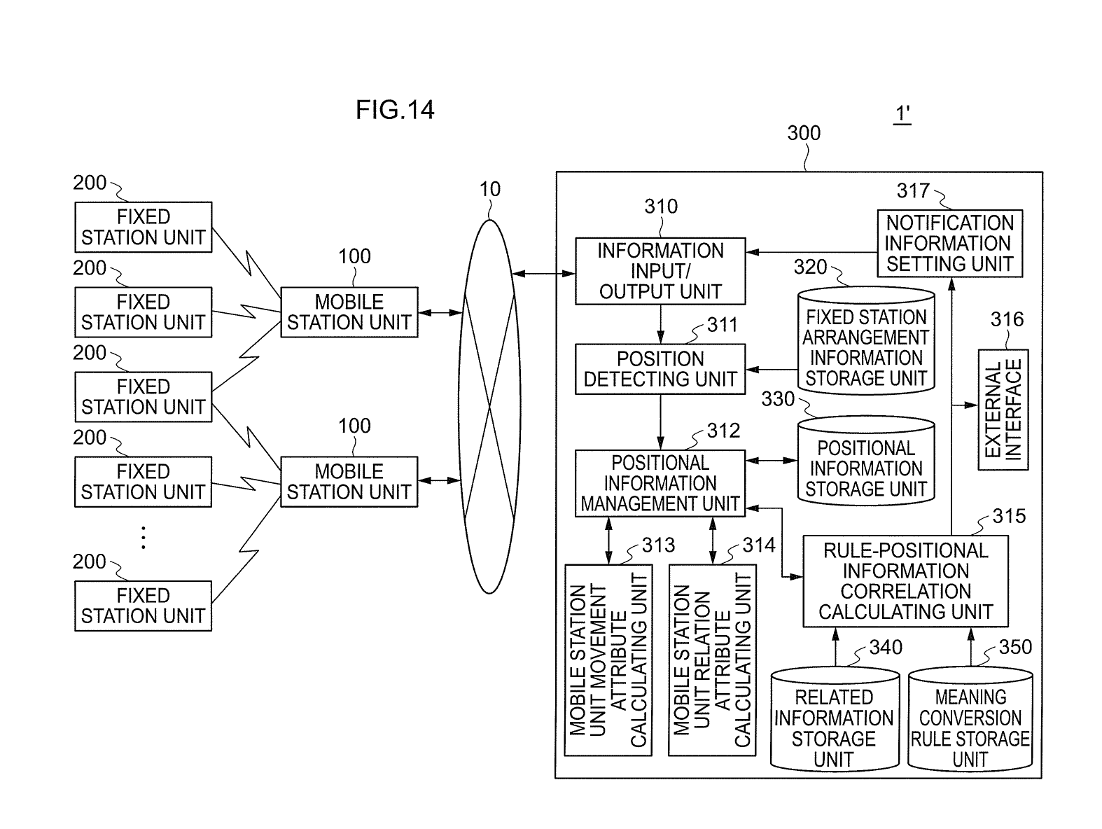

As shown in FIG. 14, in the positional information analysis system 1 according to this exemplary embodiment, for example, the mobile station unit 100 may calculate the positional information using a GPS (Global Positioning System) function. In this case, it is also possible to specify the position of the mobile station unit 100 from the positional information of the fixed station unit 200 and the relative position between the fixed station unit 200 and the mobile station unit 100. Therefore, it is enough that any one of the fixed station unit 200 and the mobile station unit 200 may calculate a position.

### Second Exemplary Embodiment

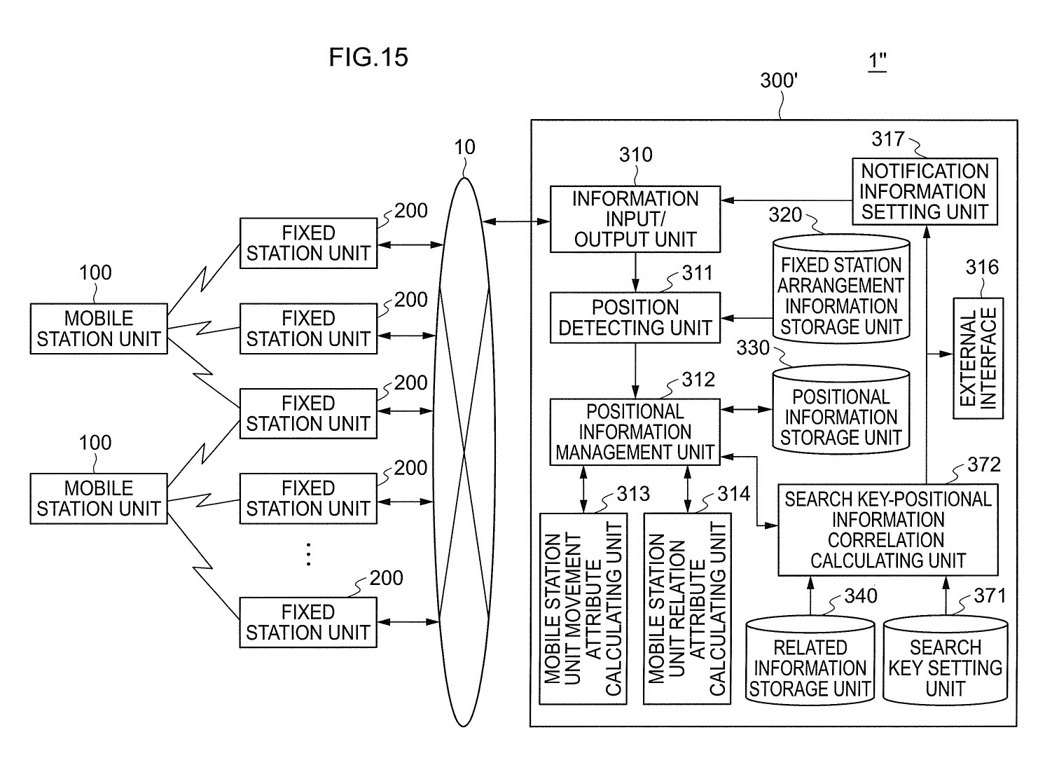

Next, a positional information analysis system 1″ according to a second exemplary embodiment of the invention will be described with reference to FIG. 15. FIG. 15 is a block diagram illustrating the structure of the positional information analysis system 1″ according to this exemplary embodiment. The positional information system 1″ according to this exemplary embodiment differs from the positional information analysis system 1 according to first exemplary embodiment in that the positional information analysis system 1″ includes a search key setting unit 371 and a search key-positional information correlation calculating unit 372 instead of the rule-positional information correlation calculating unit 315 and the meaning conversion rule storage unit 350. The difference between the second exemplary embodiment and the first exemplary embodiment will be mainly described below. A detailed description of the same functional units and processing as those in the first exemplary embodiment will be omitted.

Structure of Positional Information Analysis System>

As shown in FIG. 15, the positional information analysis system 1″ according to this exemplary embodiment includes mobile station units 100 that move together with persons or articles to be detected, fixed station units 200 that can communicate with the mobile station units 100, and a positional information analysis apparatus 300′ that analyzes the state of the mobile station unit 100 obtained from the continuous positional information of the mobile station unit 100 in real time, which are connected to each other through wireless communication or a network 10. Similar to the first exemplary embodiment, the positional information analysis apparatus 300′ includes an information input/output unit 310, a position detecting unit 311, a positional information management unit 312, a mobile station unit movement information calculating unit 313, a mobile station unit relation attribute calculating unit 314, an external interface 316, a notification information setting unit 317, a fixed station arrangement information storage unit 320, a positional information storage unit 330, and a related information storage unit 340. The positional information analysis apparatus 300′ further includes the search key setting unit 371 and the search key-positional information correlation calculating unit 372.

The search key setting unit 371 is a functional unit that can input search keys, which are search conditions. For example, a keyboard or a touch panel may be used as the search key setting unit 371. The search key input from the search key setting unit 371 is output to the search key-positional information correlation calculating unit 372 which will be described below.

The search key-positional information correlation calculating unit 372 is a functional unit that searches for the positional information of the mobile station unit 100 on the basis of the search key input from the search key setting unit 371. The search key-positional information correlation calculating unit 372 matches the positional information, the movement attribute information, and the relation attribute information of the mobile station unit 100 with the search key to calculate the positional information of the mobile station unit 100. When there is information matched with the search key, the search key-positional information correlation calculating unit 372 outputs the information to the external interface 316 and the notification information setting unit 317.

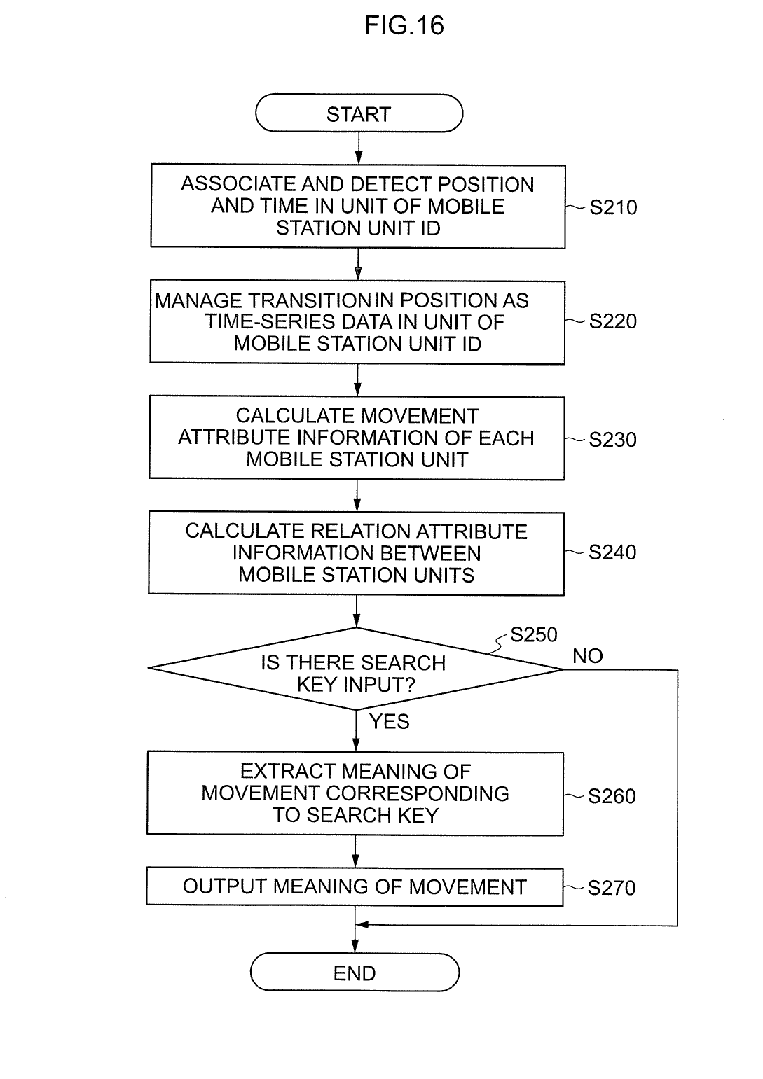

Next, a method of analyzing the positional information of the mobile station unit 100 according to this exemplary embodiment will be described with reference to FIG. 16. FIG. 16 is a flowchart illustrating the positional information analysis method according to this exemplary embodiment.

<Method of Analyzing Positional Information>

In the method of analyzing the positional information of the mobile station unit 100 according to this exemplary embodiment, as shown in FIG. 16, first, the position and the time of the mobile station unit 100 for each mobile station unit ID unit are detected so as to be associated with each other (S210). Then, a transition of the position of the mobile station unit 100 for each mobile station unit ID unit is managed as time-series data (S220). The position detecting unit 311 that has calculated the positional information of the mobile station unit 100 in Step S210 transmits the positional information of the mobile station unit 100 shown in FIG. 8 to the positional information management unit 312. The positional information management unit 312 stores the positional information of the mobile station unit 100 as a history in the positional information storage unit 330, and manages transition information of the position of the mobile station unit 100, that is, the movement line.

The movement attribute information of each mobile station unit is calculated on the basis of the positional information of the mobile station unit 100 (S230). In Step S230, the mobile station unit movement attribute calculating unit 313 calculates the movement attribute information of the mobile station unit 100 from the positional information of each mobile station unit 100. Then, the relation attribute information between the mobile station units is calculated on the basis of the positional information of each mobile station unit 100 (S240). In Step S240, the mobile station unit relation attribute calculating unit 314 calculates the relation attribute information between the mobile station units 100 from the positional information of each mobile station unit 100.

Steps S210 to S240 are similar processing as Steps S110 to S140 in the positional information analysis method according to the first exemplary embodiment. Steps S210 to S240 are performed each time the position of the mobile station unit 100 is detected.

Then, it is determined whether a search key is input (S250). In the positional information management apparatus 300′ according to this exemplary embodiment, the state attribute information of the mobile station unit 100, such as the positional information, the movement attribute information, and the relation attribute information, is calculated in real time, but a search processing using the search key is performed in non-real time. In Step S250, when the search key is input from the search key setting unit 371, the search key-positional information correlation calculating unit 372 searches for corresponding meaning information (the meaning of the movement of the mobile station unit 100) on the basis of the input search key (S260). In this exemplary embodiment, the meaning information may be, for example, a detection signal, which is a first identifier (an identifier stored in the meaning conversion rule storage unit 350, which will be described below, so as to be associated with the meaning of movement) given to each meaning of movement, a mobile station unit ID, which is a second identifier for specifying the mobile station unit 100, or the meaning of the movement of the mobile station unit 100.

Then, a list of the corresponding meaning information items is output (S270). On the other hand, when no search key is input, processing of extracting the meaning information of the mobile station unit 100 is not performed (Steps S260 and S270).

The positional information analysis method according to this exemplary embodiment has been described above. According to the positional information analysis method of this exemplary embodiment, the state attribute information of the mobile station unit 100, such as the positional information, the movement attribute information, and the relation attribute information, is calculated in real time to abstract information. In this way, it is possible to reduce a load of search processing using the search key and instantly provide the search result.

The positional information analysis system 1″ can be used to search for the previous event which occurred in the past and check it. For example, when a notebook personal computer in the office is lost, it is possible to perform a search to check an event indicating when the notebook personal computer moves or with whom the notebook personal computer moves.

The positional information analysis system 1″ according to this exemplary embodiment includes the search key setting unit 371 and the search key-positional information correlation calculating unit 372, instead of the rule-positional information correlation calculating unit 315 and the meaning conversion rule storage unit 350 according to the first exemplary embodiment, but the invention is not limited to the above-mentioned structure. The positional information analysis system 1″ according to this exemplary embodiment may further include the rule-positional information correlation calculating unit 315 and the meaning conversion rule storage unit 350.

### Third Exemplary Embodiment

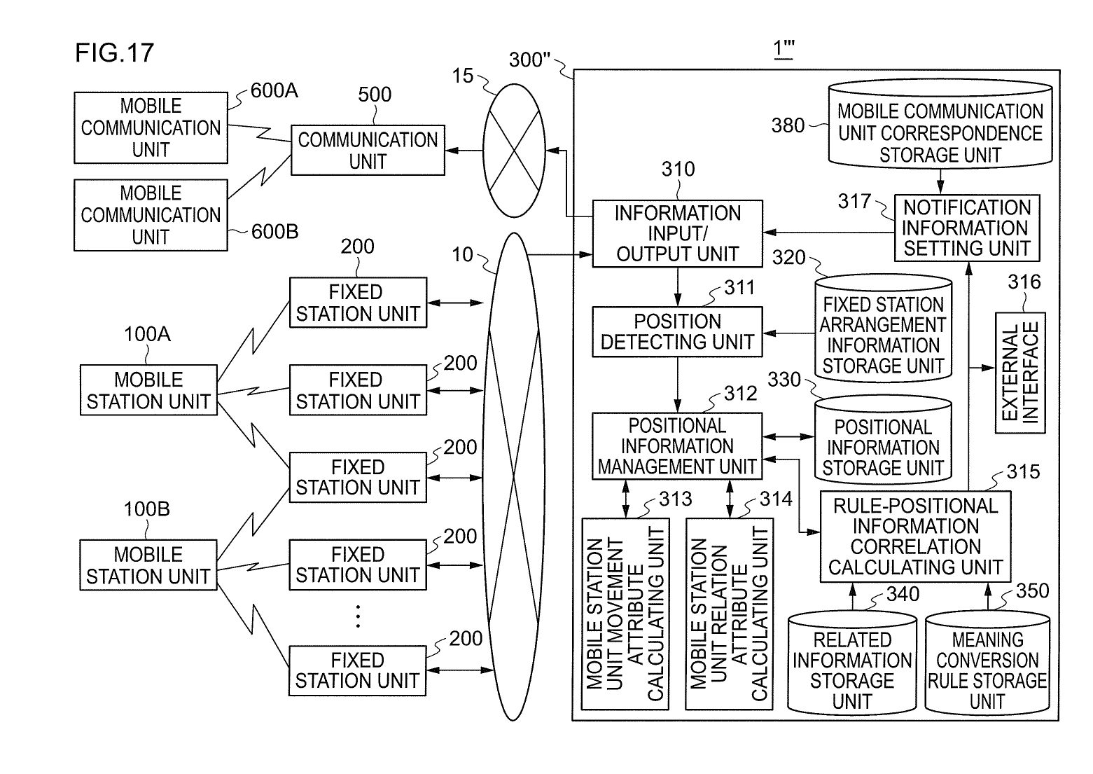

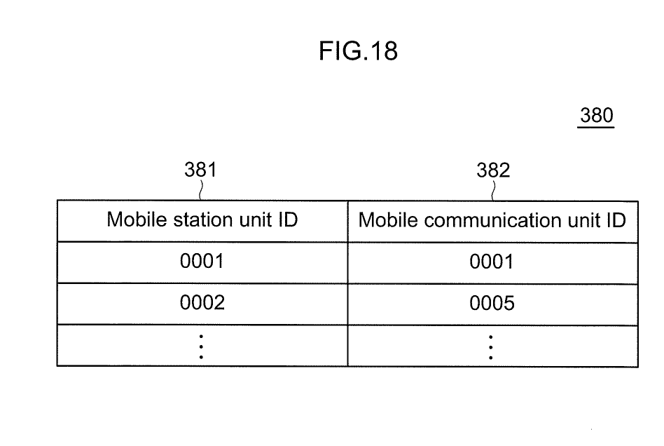

Next, a positional information analysis system 1″′ according to a third exemplary embodiment of the invention will be described with reference to FIGS. 17 and 18. FIG. 17 is a block diagram illustrating the structure of the positional information analysis system 1″′ according to this exemplary embodiment. FIG. 18 is a diagram illustrating content stored in a mobile communication unit correspondence storage unit according to this exemplary embodiment. The positional information system 1″′ according to this exemplary embodiment differs from the positional information analysis system 1 according to the first exemplary embodiment in that the positional information system 1″′ includes a mobile communication unit correspondence storage unit 380 and meaning information is transmitted from a positional information analysis apparatus 300″ to a mobile communication unit 600 that moves together with the mobile station unit 100. Next, the difference between the third exemplary embodiment and the first exemplary embodiment will be mainly described. A detailed description of the same functional units and processing as those in the first exemplary embodiment will be omitted.

<Structure of Positional Information Analysis System>

As shown in FIG. 17, the positional information analysis system 1′ according to this exemplary embodiment includes mobile station units 100 that move together with persons or articles to be detected, fixed station units 200 that can communicate with the mobile station units 100, and a positional information analysis apparatus 300″ that analyzes the state of the mobile station unit 100 obtained from the continuous positional information of the mobile station unit 100 in real time, which are connected to each other through wireless communication or a network 10. The positional information analysis apparatus 300″ is connected to a communication unit 500 through a network 15 and can transmit information to the mobile communication unit 600 through the communication unit 500. The communication unit 500 has a function of transmitting notification information from the positional information analysis apparatus 300″ to the mobile communication unit 600. The mobile communication unit 600 can communicate with the communication unit 500 and move together with the mobile station unit 100. For example, the mobile communication unit 600 is a mobile communication terminal.

Similar to the first exemplary embodiment, the positional information analysis apparatus 300′ includes an information input/output unit 310, a position detecting unit 311, a positional information management unit 312, a mobile station unit movement information calculating unit 313, a mobile station unit relation attribute calculating unit 314, a rule-positional information correlation calculating unit 315, an external interface 316, a notification information setting unit 317, a fixed station arrangement information storage unit 320, a positional information storage unit 330, a related information storage unit 340, and a meaning conversion rule storage unit 350. The positional information analysis apparatus 300″ further includes the mobile communication unit correspondence storage unit 380.

The mobile communication unit correspondence storage unit 380 is a storage unit that stores a mobile station unit ID for specifying each mobile station unit 100 and a mobile communication unit ID for specifying the mobile communication unit 600 so as to associate them with each other, and includes a memory, such as a RAM or a hard disk. As shown in FIG. 18, the mobile communication unit correspondence storage unit 380 stores, for example, a mobile station unit ID 381 and a mobile communication unit ID 382 so as to associate them with each other.

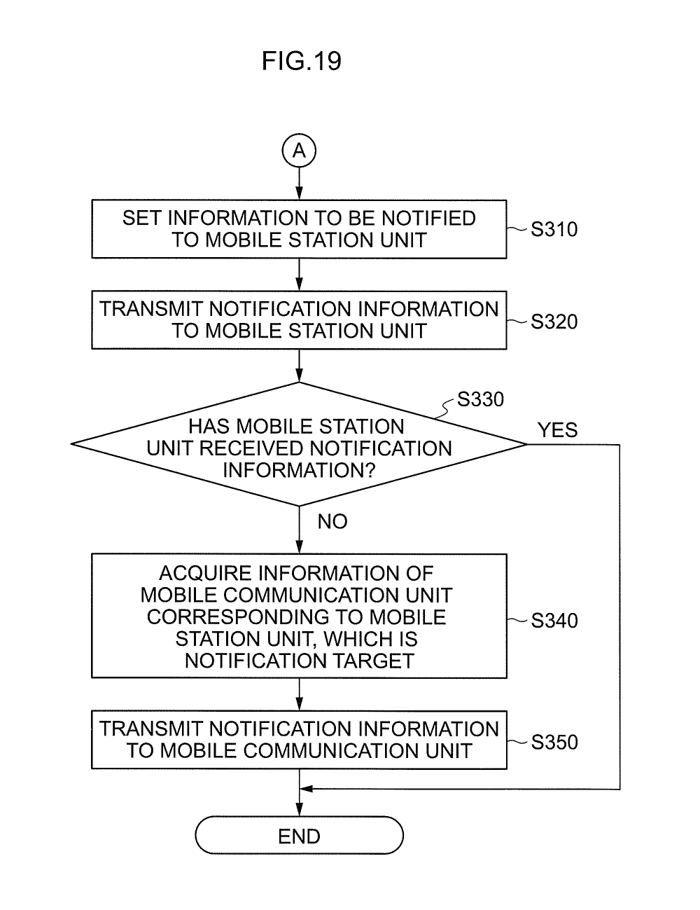

Next, a method of transmitting notification information to the mobile communication unit 600 according to this exemplary embodiment will be described with reference to FIG. 19. FIG. 19 is a flowchart illustrating the information notifying method according to this exemplary embodiment. In the information notifying method, when it is impossible to transmit notification information to the mobile station unit 100, the notification information is transmitted to the mobile communication unit 600 that moves together with the mobile station unit 100.

<Method of Transmitting Notification Information to Mobile Communication Unit>

As shown in FIG. 19, in the method of transmitting notification information to the mobile communication unit 600 according to this exemplary embodiment, first, notification information to be transmitted to the mobile station unit 100 is set (S310). For example, the notification information transmitted to the mobile station unit 100 is the meaning of the movement of the mobile station unit 100 corresponding to the detection signal calculated by the rule-positional information correlation calculating unit 315 (for example, the detection event 351 stored in the meaning conversion rule storage unit 350), or information to be notified to the mobile station unit 100 from the meaning of the movement. The notification information setting unit 317 sets the content and format of the notification information transmitted to the mobile station unit 100.

Then, the notification information is transmitted to the mobile station unit 100 (S320). The notification information is transmitted from the information input/output unit 310 of the positional information analysis apparatus 300″ to the fixed station unit 200 through the network 10, and is then transmitted to the mobile station unit 100.

It is confirmed whether the mobile station unit 100 receives the notification information (S330). Whether the mobile station unit 100 receives the notification information may be determined by a return notice indicating whether reception succeeds or fails, which is transmitted from the mobile station unit 100 to the positional information analysis apparatus 300″. In Step S330, it may be confirmed whether it is possible to display the received notification information on a display unit (not shown) of the mobile station unit 100 as well as whether the mobile station unit 100 receives the notification information. That is, in this processing, it is checked whether there occur errors in the mobile station unit 100 that receives the notification information.

When the mobile station unit 100 succeeds in receiving the notification information, the processing ends. However, when the mobile station unit 100 fails in receiving the notification information, it is tried to transmit the notification information to the mobile communication unit 600 that moves together with the mobile station unit 100, which is a notification target. First, the information of the mobile communication unit 600 to which the notification information will be transmitted is acquired (S340). The notification information setting unit 317 acquires the mobile communication unit ID of the mobile communication unit 600 corresponding to the mobile station unit 100, which is a notification target, with reference to the mobile communication unit correspondence storage unit 380. Then, the notification information is transmitted to the mobile communication unit 600 with the acquired mobile communication unit ID (S350).

For example, when the mobile station unit ID of a mobile station unit 100A shown in FIG. 17 is ‘0001 ’, a mobile communication unit ID corresponding to the mobile station unit 100A is ‘0001 ’. In addition, it is assumed that the mobile communication unit ID of a mobile communication unit 600A shown in FIG. 17 is ‘0001 ’. In this case, the notification information that could not be transmitted to the mobile station unit 100A is transmitted to the mobile communication unit 600A.

The method of transmitting notification information to the mobile communication unit 600 according to this exemplary embodiment has been described above. According to the information notifying method, when the mobile station unit 100 cannot receive or display notification information, it is possible to transmit the notification information to the mobile communication unit that moves together with the mobile station unit 100. In this way, it is possible to reliably transmit notification information to the user that holds the mobile station unit 100. For example, when the mobile station unit 100 is an active RFID and the mobile communication unit 600 is a mobile phone, it is possible to transmit notification information to the mobile communication unit 600 and transmit information to the user in real time even though the mobile station unit 100 does not have a display unit.

The exemplary embodiments of the invention have been described above with reference to the accompanying drawings, but the invention is not limited thereto. It will be understood by those skilled in the art that various modifications and changes of the invention can be made within the range of the claims and the modifications and changes are also included in the technical range of the invention.

For example, in the above-described exemplary embodiments, the communication between the mobile station unit 100 and the fixed station unit 200 is performed by electrical waves, but the invention is not limited thereto. For example, the communication between the mobile station unit 100 and the fixed station unit 200 may be performed by light or ultrasonic waves. In addition, the following structure may be used: the mobile station unit 100 is not be provided, a monitoring camera is used to detect the movement line, images are used to authenticate persons or articles, thereby identifying individuals of the persons and the articles, and the identified information is used as the mobile station unit ID.

In the above-described exemplary embodiments, the fixed station unit 200 is fixed at a specific position, but the invention is not limited thereto. The fixed station unit 200 is not necessarily fixed, but may moves as long as it is possible to specify the position of the mobile station unit 100. For example, In the case of a GPS, the fixed station unit 200 is a satellite and the mobile station unit 100 is a GPS receiver. A satellite, which is the fixed station unit 200, is not in a stationary state, but orbits the earth. However, it is possible to specify the position of the satellite on the basis of orbit information obtained from GPS signals. Therefore, it is possible to specify the position of a GPS receiver, which is the mobile station unit 100, by calculating a relative distance from the satellite. Alternatively, for example, a GPS receiver may be provided in the fixed station unit 200. In this case, it is possible to detect a new position of the fixed station unit 200 using the GPS even when the position of the fixed station unit 200 changes. In this case, the position of the fixed station unit 200 is stored in the fixed station arrangement information storage unit 320 through the network each time the position of the fixed station unit 200 is changed.

In the above-described exemplary embodiments, the mobile station unit 100 is detected by an electrical wave system, such as a UWB, but the invention is not limited thereto. For example, in order to detect the position of the mobile station unit 100, the following methods may be used: a method of detecting the position using an infrared beacon, a visible light beacon, and ultrasonic waves; a method of detecting the position using the image processing of a monitoring camera; and a self-navigation method using an acceleration sensor.

The application is based on Japanese patent application No. 2007-242086, the disclosure of which is incorporated hereinto by reference.

1. A positional information analysis apparatus that analyzes, in real time, a state of a mobile station unit which is obtained from continuous positional information of the mobile station unit, the mobile station unit moving together with a detection target, comprising:
a position detecting unit that calculates positional information which indicates a position of a mobile station unit;
a positional information storage unit that stores the positional information calculated by the position detecting unit as a history for the mobile station unit;
a state attribute calculating unit that calculates state attribute information which indicates a state of the mobile station unit from the history of the positional information of the mobile station unit each time the position detecting unit calculates the position of the mobile station unit;
a meaning conversion rule storage unit that stores a first identifier which is given to a meaning of a movement of a mobile station unit and a rule which detects the meaning of the movement so as to associate the first identifier and the rule with each other; and
a rule-positional information correlation calculating unit that determines whether the rule is matched on the basis of the positional information and the state attribute information of the mobile station unit and outputs the first identifier associated with the rule which is determined to be matched.

2. The positional information analysis apparatus of claim 1, wherein the rule-positional information correlation calculating unit determines whether the rule is matched on the basis of the positional information and the state attribute information of the mobile station unit and further outputs a second identifier which identifies the mobile station unit which is determined to be matched with the rule.

3. The positional information analysis apparatus of claim 1, wherein the position detecting unit calculates the positional information which indicates the position of the mobile station unit on the basis of position specification information which specifies the position of the mobile station unit received from a fixed station unit and positional information of the fixed station unit.

4. The positional information analysis apparatus of claim 1, further comprising a search information input unit to which search information is input,
wherein the rule-positional information correlation calculating unit outputs the meaning of the movement of the mobile station unit that matches the search information as event information on the basis of the positional information and the state attribute information of the mobile station unit.

5. The positional information analysis apparatus of claim 1, wherein the state attribute calculating unit calculates movement attribute information which indicates the movement of the mobile station unit as the state attribute information.

6. The positional information analysis apparatus of claim 1, wherein the state attribute calculating unit calculates relation attribute information which indicates a relation of positions and movements between mobile station units as the state attribute information.

7. The positional information analysis apparatus of claim 1, wherein the rule-positional information correlation calculating unit outputs the first identifier each time the position detecting unit calculates the position of the mobile station unit.

8. The positional information analysis apparatus of claim 1, further comprising a notification information setting unit that generates, from the first identifier which is output from the rule-positional information correlation calculating unit, notification information which notifies a notification unit that accompanies the detection target.

9. The positional information analysis apparatus of claim 8, wherein the notification unit is the mobile station unit.

10. The positional information analysis apparatus of claim 1, further comprising:
an advertisement display unit management unit that transmits advertisement information which corresponds to the first identifier output from the rule-positional information correlation calculating unit to an advertisement display unit which displays the advertisement information; and
an advertisement display unit arrangement storage unit that stores a position of the advertisement display unit,
wherein the advertisement display unit management unit selects the advertisement display unit which is closest to the mobile station unit which corresponds to the rule associated with the first identifier, and transmits the advertisement information to the selected advertisement display unit.

11. (canceled)

12. A positional information analysis method that analyzes, in real time, a state of a mobile station unit which is obtained from continuous positional information of the mobile station unit, the mobile station unit moving together with a detection target, comprising:
calculating positional information which indicates a position of a mobile station unit;
storing the calculated positional information as a history for the mobile station unit;
calculating state attribute information which indicates a state of the mobile station unit from the history of the positional information of the mobile station unit each time calculating the position of the mobile station unit; and
determining whether a rule which detects a meaning of a movement of the mobile station unit is matched on the basis of the positional information and the state attribute information of the mobile station unit and outputting a first identifier which is given to the meaning of the movement of the mobile station unit and is associated with the rule which is determined to be matched.

13. The positional information analysis method of claim 12, wherein the outputting the first identifier further includes:
determining whether the rule is matched on the basis of the positional information and the state attribute information of the mobile station unit; and
outputting a second identifier which identifies the mobile station unit which is determined to be matched with the rule.

14. The positional information analysis method of claim 12, wherein the calculating the positional information further includes calculating the positional information which indicates the position of the mobile station unit on the basis of position specification information which specifies the position of the mobile station unit received from a fixed station unit and positional information of the fixed station unit.

15. The positional information analysis method of claim 12, further comprising acquiring search information,
wherein the outputting the first identifier further includes outputting the meaning of the movement of the mobile station unit that matches the search information as event information on the basis of the positional information and the state attribute information of the mobile station unit.

16. The positional information analysis method of claim 12, wherein the calculating the state attribute information further includes calculating movement attribute information which indicates the movement of the mobile station unit as the state attribute information.

17. The positional information analysis method of claim 12, wherein the calculating the state attribute further includes calculating relation attribute information which indicates a relation of positions and movements between mobile station units as the state attribute information.

18. The positional information analysis method of claim 12, wherein the outputting the first identifier further includes calculating the first identifier each time the position of the mobile station unit is calculated.

19. The positional information analysis method of claim 12, further comprising converting the output first identifier into notification information which notifies a notification unit that accompanies the detection target.

20. The positional information analysis method of claim 19, wherein the notification unit is the mobile station unit.

21. The positional information analysis method of claim 12, further comprising:
transmitting advertisement information which corresponds to the output first identifier to an advertisement display unit which displays the advertisement information,
wherein the transmitting the advertisement information further includes:
selecting the advertisement display unit which is closest to the mobile station unit which corresponds to the rule associated with the first identifier on the basis of a position of the advertisement display unit; and
transmitting the advertisement information to the selected advertisement display unit.

22. (canceled)

23. A positional information analysis system that analyzes, in real time, a state of a mobile station unit which is obtained from continuous positional information of the mobile station unit, the mobile station unit moving together with a detection target, comprising:
a fixed station unit that outputs position specification information which specifies a position of a mobile station unit; and
a positional information analysis apparatus that acquires meaning information of a movement of the mobile station unit on the basis of continuous positional information of the mobile station unit which is calculated from the position specification information,
wherein the fixed station unit includes:
a position specification information transmitting unit that transmits the position specification information which specifies the position of the mobile station unit to the positional information analysis apparatus, and
the positional information analysis apparatus includes:
a position detecting unit that calculates positional information which indicates the position of the mobile station unit on the basis of the position specification information received from the fixed station unit and positional information of the fixed station unit;
a positional information storage unit that stores the positional information calculated by the position detecting unit as a history for the mobile station unit;
a state attribute calculating unit that calculates state attribute information which indicates a state of the mobile station unit from the history of the positional information of the mobile station unit each time the position detecting unit calculates the position of the mobile station unit;
a meaning conversion rule storage unit that stores a first identifier which is given to the meaning of the movement of the mobile station unit and a rule which detects the meaning of the movement so as to associated the first identifier and the rule with each other; and
a rule-positional information correlation calculating unit that determines whether the rule is matched on the basis of the positional information and the state attribute information of the mobile station unit and outputs the first identifier associated with the rule which is determined to be matched.
